(19) United States
(12) Patent Application Publication
(10) Pub. No.: US 2026/0350483 A1
(43) Pub. Date: Nov. 5, 2026

(54) PARALLEL MACHINE LEARNING OPTIMIZATION PIPELINES FOR OPTIMIZING TIME AND CAPACITY PREDICTIONS

(71) Applicant: Optum, Inc., Minnetonka, MN (US)

(72) Inventors: Arun Kumar TIWARI, Delhi (IN); Srinjay NATH, Uttar Pradesh (IN); Amardeep SHARMA, Delhi (IN); Deepak SINGH, Dist-Deoria (IN); Sundeep S. SINGH, Odisha (IN); Alice S. Nistler, Fairfax, VA (US)

(21) Appl. No.: 19/194,140

(22) Filed: Apr. 30, 2025

(51) Int. Cl. G06N 20/20

(52) U.S. Cl. CPC G06N 20/20

(57) ABSTRACT

Various embodiments of the present disclosure provide a parallel processing architecture that improves the functionality of a computer in various aspects. The techniques comprise generating, using a clustering model of first pipeline, a group of entity clusters from a set of entities associated with a target repository and generate, using a first staged prediction model of the first pipeline, an aggregate time prediction for the target repository. The techniques comprise generating an aggregate capacity prediction for the target repository based on a set of providers associated with the target repository and synthesizing the aggregate time prediction and the aggregate capacity prediction to generate a utilization indication for the target repository.

### BACKGROUND

Traditional optimization techniques may leverage machine capabilities to optimize a dataset based on correlations learned by a machine learning model over time. Historically, attempts to automate optimization techniques have employed basic statistical models or single-stage machine learning algorithms. Such model approaches, however, struggle to account for counteracting variables within a dataset. For example, they may oversimplify complex relationships, fail to capture important nuances in data patterns, or lack the flexibility to adapt to changing conditions over time. Additionally, traditional approaches often struggle with computational efficiency when scaling to large datasets or high-dimensional feature spaces.

### BRIEF DESCRIPTION OF THE DRAWINGS

FIG. 1 depicts a block diagram of an example architecture in accordance with some embodiments of the present disclosure.

FIG. 2 depicts a block diagram of an example predictive data analysis computing entity in accordance with some embodiments of the present disclosure.

FIG. 3 depicts a block diagram of an example client computing entity in accordance with some embodiments of the present disclosure.

FIG. 4 depicts a dataflow diagram of a parallel machine learning optimization pipeline in accordance with some embodiments of the present disclosure.

FIG. 5 depicts a dataflow diagram of a time prediction model pipeline in accordance with some embodiments of the present disclosure.

FIG. 6 depicts a dataflow diagram of a capacity prediction model pipeline in accordance with some embodiments of the present disclosure.

FIG. 7 depicts a flowchart diagram of parallel machine learning optimization process in accordance with some embodiments of the present disclosure.

### DETAILED DESCRIPTION

Unlike conventional single-stage or single-pipeline machine learning solutions, embodiments of the present disclosure provide a specialized parallel machine-learning architecture that reduces computational overhead, improves processing throughput by distributing prediction tasks across multiple dedicated prediction generation streams, and increases the accuracy of predictions that are time and capacity dependent. In particular, a parallel machine learning optimization pipeline is implemented using a specialized multi-threaded and/or distributed architecture that manages separate hardware resources (e.g., different processor cores, graphics processing units (GPUs), tensor processing unites (TPUs), and/or memory partitions) for up to each prediction stream. This design materially improves the functionality of the underlying computer system by (1) reducing the time needed to generate high-fidelity predictions from large datasets, (2) mitigating resource contention through orchestrated parallel processing, and (3) leveraging multiple types of prediction models in a coordinated manner that cannot be practically performed by a single monolithic model running on generic hardware.

In some examples, the parallel machine learning pipeline may comprise at least two machine-learned model pipelines to generate counteracting predictions (e.g., time and capacity predictions) in parallel. To overcome performance deficiencies with traditional, single stage machine learning approaches, each of the model pipelines may be isolated from the other and configured to forecast a prediction that counteracts the predictions of the other pipeline. For example, in a time (e.g., a predicted time requirements) and capacity (e.g., a predicted capacity to handle time requirements) use case in which an unknown amount of future time requirement must be balanced with an unknown amount of capacity to handle time requirements, the first model pipeline may be configured to independently predict an aggregate time prediction (e.g., a forecasted amount of time) for a set of entities (e.g., computer programs, healthcare members, and any other entity that consumes time from a provider in various different use cases) within a repository, while a second model pipeline may be configured to independently predict an aggregate capacity prediction (e.g., a forecasted capacity to handle time requirements) for an associated set of providers (e.g., computers, healthcare providers, and any other entity with the capacity to allocated time in various different use cases) within the repository. These counteracting predictions, forecasted in isolation, may then be synthesized to perform an optimization task for the repository. By doing so, the parallel machine learning optimization pipeline implements a parallel processing stream that breaks a complex optimization process into multiple sub-tasks handled by machine learning. Moreover, by isolating the related model pipelines with respect to each of two counteracting predictions, the parallel machine learning optimization pipeline enables the execution of more complex prediction architectures within parallel processing streams of the optimization task. This leads to improved prediction accuracy for optimization tasks, without sacrificing processing speeds.

More particularly, some embodiments of the present disclosure provide an improved time prediction model pipeline within a first parallel processing stream of a parallel optimization framework. The time prediction model connects a first configuration of models to break a time prediction task into a series of prediction stratification that are each tailored for a different type of input entity. This allows for separate predictions, and training/inference branches, for different levels of prediction complexity. For example, a first model may be tailored to a complex entity type (e.g., a large program, a complex patient) that requires large time requirements throughout a prediction time period, whereas a second model may be tailored to a single entity type (e.g., a small program, a less complex patient) that requirement small time requirement throughout the prediction time period. To more efficiently (e.g., in terms of processing speeds, training, and accuracy) handle different prediction stratification, the time prediction model pipeline may connect a sequence of different machine learning models of one or more different architectures that are each designed for a particular stratification of entities within the dataset. For example, the models may comprise a unique combination of clustering models (e.g., unsupervised machine learning model), regression models, and classification models. The clustering models may cluster entities into groups of entity clusters that may be leveraged to train downstream cluster-specific prediction models to provide abstractive predictive insights for a particular entity with respect to a cluster in which it belongs. In addition, or alternatively, an entity-specific model may be trained and/or fitted to entity-specific attributes to generate entity-level predictions that provide granular predictive insights for a particular entity. At inference, the time prediction model pipeline may execute, in parallel or in sequence, a set of trained cluster-specific and entity-specific models to generate a set of abstractive and granular entity predictions. These predictions may be synthesized to generate improved (e.g., in terms of accuracy) temporal forecasts for an entity that are capable of leveraging insights exhibited by different stratifications of a dataset, as opposed to the singularly focused machine learning techniques that are traditionally used.

In addition, or alternatively, some embodiments of the present disclosure provide an improved capacity prediction model pipeline within a second stream of a parallel optimization framework. The capacity prediction model connects a second configuration of models to break a capacity prediction task into a series of prediction stratifications that are each tailored for a different predictive aspects of an input provider. The capacity prediction model pipeline may connect a sequence of different machine learning models of one or more different architectures that are each designed for a particular stratification of provider attributes within the dataset. For example, the models may comprise a unique combination of regression and classification models that may each be fitted, trained, and/or otherwise configured for a different predictive aspect of a capacity prediction using different portions of attributes of a particular provider. At inference, the capacity prediction model pipeline may execute, in parallel or in sequence, a sequence of trained regression and classification models to generate a set of predictions from one or more portions of real time data for a provider. These predictions may be synthesized to generate improved (e.g., in terms of accuracy) capacity forecasts for a provider that are capable of leveraging insights exhibited by different stratifications of a provider attributes, as opposed to the singularly focused machine learning techniques that are traditionally used.

Examples of technologically advantageous embodiments of the present disclosure comprises improved machine learning pipelines that operate in an unconventional fashion to improve the predictive accuracy of optimization tasks, while reducing time constraints in complex optimization processes, among other aspects of the present disclosure. Other technical improvements and advantages may be realized by one of ordinary skill in the art.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

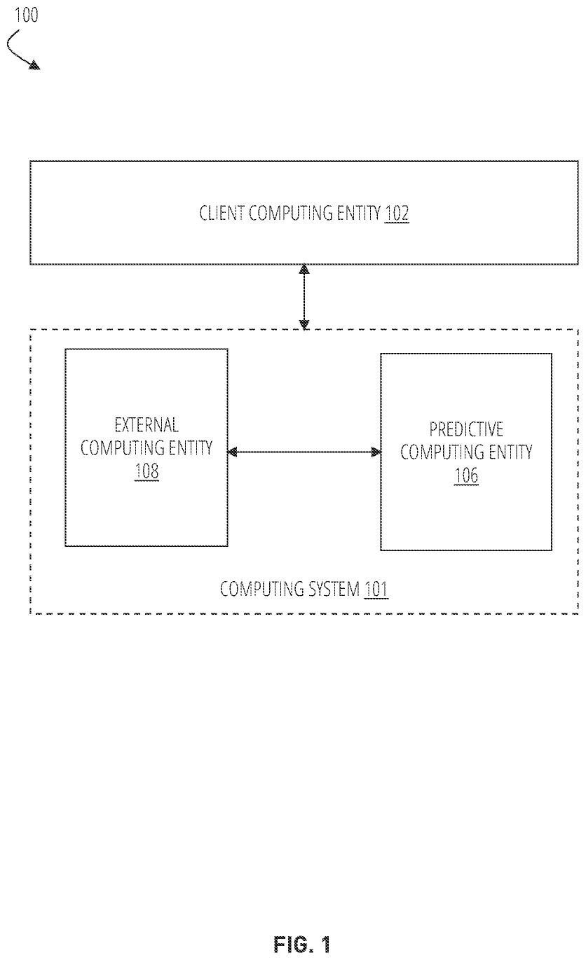

FIG. 1 depicts a block diagram of an example architecture 100 in accordance with some embodiments of the present disclosure. The architecture 100 comprises a computing system 101 configured to receive a request, such as an optimization request, and/or the like, from client computing entities 102, process the optimization request, and provide optimization responses to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learned models may be trained to generate component predictions and/or other machine learned outputs. The models may be adapted to a parallel processing architecture to collectively process a request via parallel processing streams. Some techniques of the present disclosure may adapt traditional models to a cohesive framework, such as the parallel machine learning optimization pipeline, for more efficiently handling optimization tasks for target repositories.

In some embodiments, the computing system 101 may communicate with at least one of the client computing entities 102 using one or more communication networks. Examples of communication networks comprise any wired or wireless communication network comprising, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate a code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., optimization techniques) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as the target repositories, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

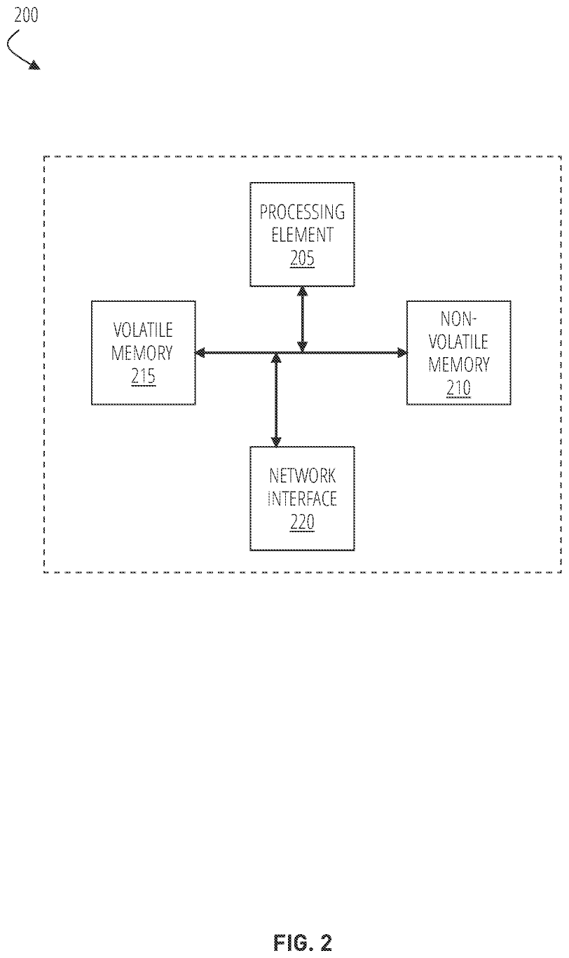

FIG. 2 depicts a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable quantum gate arrays, programmable logic arrays (PLAs), hardware accelerators, other circuitry, and/or the like. With respect to quantum computing embodiments of the computing entity 200, the processing element 205 may comprise specialized components for manipulating and measuring quantum states. These components may comprise quantum gates that perform operations on one or more qubits, quantum circuits that combine multiple gates to implement algorithms, measurement devices that extract classical information from quantum state, and/or the like. The quantum gates, circuits, and/or the like may be controlled, using one or more error correction mechanisms to compensate for decoherence and other quantum noise effects, to maintain quantum coherence while performing computations.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably), volatile memory 215 (also referred to as volatile media, storage, memory storage, memory circuitry, and/or similar terms used herein interchangeably), quantum memory (e.g., solid quantum memory, atomic gas quantum memory), and/or the like.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium comprising random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

In some embodiments, quantum memory comprises a memory structure that utilize quantum bits, or qubits, which may exist in multiple states simultaneously through a property called superposition. Unlike classical bits that may only be in a state of 0 or 1, qubits may represent both states at once, allowing for exponentially larger information storage capacity. These quantum memory structures must maintain quantum coherence, which refers to the delicate quantum mechanical state of the system, while also allowing for rapid access and manipulation of stored quantum information.

As will be recognized, the non-volatile memory 210, the volatile memory 215, and/or the quantum memory may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

In some embodiments, one or more embodiments of the present disclosure may be implemented using general and/or specialized quantum computers. For example, the computing entity 200 may comprise quantum memory and/or quantum processing elements, as described herein, that may be configured for general processing and/or specialized processing tasks. In some examples, the quantum memory and/or quantum processing elements of the computer entity 200 may be specialized for machine learning task. By way of example, large language models (LLMs) and other transformer networks may be specially designed for operation within a quantum environment by replacing weight matrices in self-attention and/or multi-layer perceptron layers of such models with one or more combinations of two variational quantum circuits and/or a quantum-inspired tensor networks, such as a matrix product operator (MPO). In this way, LLM functionality may be enabled within a quantum environment by decomposing weight matrices through the application of tensor network disentanglers and MPOs. Similarly, quantum support vector machines, quantum neural networks, and/or any other machine learning architecture may be modified to a quantum environment for implementation by the computing entity 200. Thus, the machine learning architectures of the present disclosure may be configured for classical computer or quantum computers based on the embodiment.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

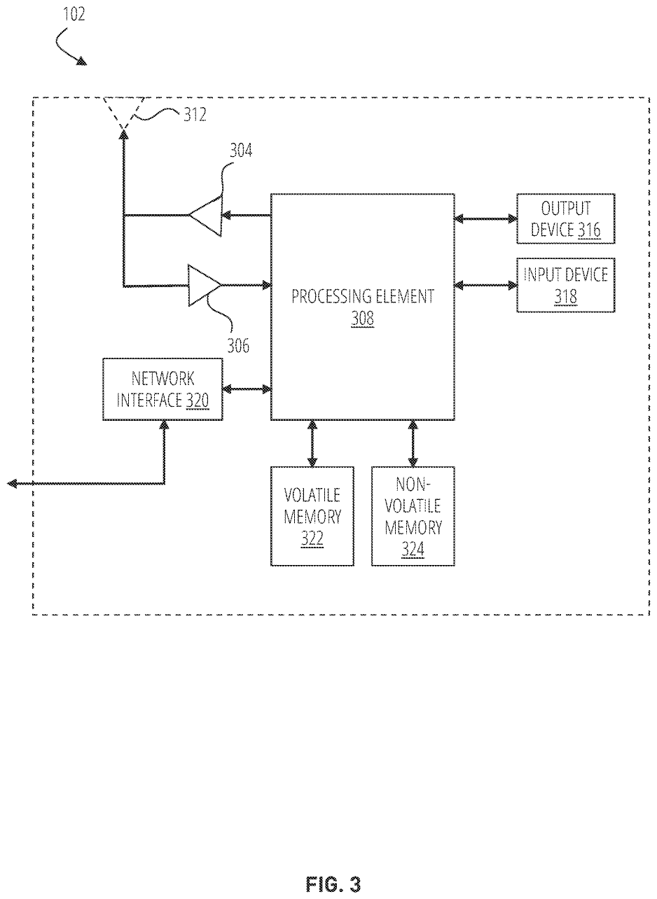

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., including executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. Example System Operations

As indicated, various embodiments of the present disclosure make important technical contributions to machine learning-based optimization methodologies. In particular, systems and methods are disclosed herein that implement machine learning and optimization techniques to improve the optimization of large scale system resources, such as processing and memory resources within a computing ecosystem. By doing so, the machine learning and optimization techniques of the present disclosure enable improved resource allocation processes that, when executed on a computer, improves computer processing and memory efficiencies with respect to various tasks. This, in turn, may improve the functionality of a computer with respect to various computing tasks, including machine learning, data optimization, and the like.

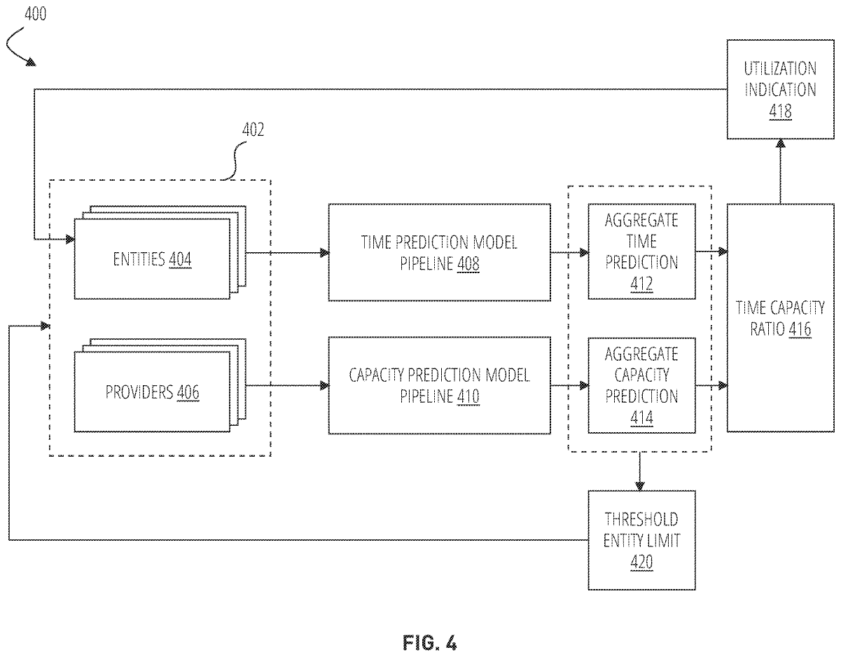

FIG. 4 depicts a dataflow diagram of a parallel machine learning optimization pipeline 400 in accordance with some embodiments of the present disclosure. The parallel machine learning optimization pipeline 400 defines two pipelines that may be executed by a computing system, such as the computing system 101 of the present disclosure, to forecast counteracting predictions, the aggregate time prediction 412 and aggregate capacity prediction 414, that may be combined to optimize the performance of a target repository 402. A first pipeline, for example, may comprise a time prediction model pipeline 408 that may individually configured and/or trained to forecast a time requirement (e.g., an aggregate time prediction 412) for a set of entities 404 within the target repository 402, whereas a second pipeline, the capacity prediction model pipeline 410, may be configured and/or trained to forecast a capacity (e.g., the aggregate capacity prediction 414) of a set of providers 406 within the target repository 402 to handle the set of entities 404. In some examples, a computing system 101 may execute each pipeline of the parallel machine learning optimization pipeline 400 in parallel to generate counteracting predictions that correspond to one another in time. In this way, the parallel machine learning optimization pipeline 400 may enable a computing system 101 to break a complex optimization task into two separate pipelines specialized for a portion of the overall task without reductions in accuracy due to temporal misalignments. This, in turn, leads to better predictions (e.g., in terms of accuracy and comprehensiveness) than traditional optimization approaches by allowing for the implementation of more sophisticated and complex prediction pipelines tailored to a particular counteracting portion of a holistic optimization problem.

In some embodiments, the computing system 101 receives an optimization request that identifies the target repository 402. The optimization request, for example, may comprise a communication provided to the computing system 101 to assess the target repository 402. For example, the optimization request may comprise an API call or other message format that is processed by one or more computer processors. The request may comprise data that identifies the target repository 402, such as a repository identifier, which is to be evaluated using the parallel machine learning optimization pipeline 400 of the present disclosure. When received by the computing system 101, the optimization request may trigger a series of computational steps to retrieve relevant data from the target repository 402 and apply machine learning models, in accordance with parallel pipelines of the present disclosure, to process a set of entities 404 and/or a set of providers 406 associated with the target repository 402.

In some embodiments, the target repository 402 comprises one or more data storage devices that store data associated with a target optimization task. The target optimization task, for example, may comprise a time optimization task that balances time capacity of a set of providers 406 with time requirements of a set of entities 404 in any of various use cases across different domains. The data storage devices and/or data stored therein may depend on the use case and/or domain of the target optimization task. As one example, in a healthcare domain, a target optimization task may comprise a healthcare panel optimization task in which the capacity of healthcare providers (e.g., the set of providers 406) in a healthcare panel may be optimized with respect to a set of patients (e.g., the set of entities 404) a set of patient time requirements for an observational time period. As another example, in a computer infrastructure domain, a target optimization task may comprise a processing optimization task in which the processing capacity of computing devices (e.g., the set of providers 406) in a computing ecosystem may be optimized with respect to a set of applications (e.g., the set of entities 404).

In any domain, the target repository 402 may comprise provider data associated with a set of providers 406 and entity data associated with a set of entities 404 that may be leveraged by the parallel machine learning optimization pipeline 400 to generate an utilization indication 418 for the target repository 402. The target repository 402, for example, may comprise a central data source that aggregates data from and/or connects the computing system 101 to a set of external data sources associated with a target optimization task (e.g., a healthcare panel, computing ecosystem). During operation, the computing system 101 may query the target repository 402 (and/or the external data sources connected thereby) to retrieve data for input to one or more models of the present disclosure. In some examples, for instance to enable real time predictions, the target repository 402 may be regularly updated with new data from one or more input mechanisms for the target optimization task. The input mechanisms, for example, may comprise electronic health record systems, scheduling software, healthcare information systems, and/or the like for a healthcare domain, computer logs, activity reports, application manuals, and/or the like for a computer infrastructure domain, and/or the like. In this manner, the target repository 402 may enable real time predictions to support optimization tasks with the most current information available.

In some embodiments, an entity of the set of entities 404 is a unit of information that requires an allocation of time within an observation time period optimized by the optimization task. An entity may depend on the optimization task. For example, the entity may comprise a patient in a healthcare panel optimization task, an application in a processing optimization task, and/or the like. In any domain, an entity represents a unit that requires time within an observation time period in the context of resource allocation and optimization. In the healthcare example, for instance, the entity may correspond to a person that receives healthcare services over the observation time period. In the computing ecosystem example, the entity may correspond to an application that receives processing, memory, and/or any other computing resources over the observation time period.

In some examples, an entity may correspond to one or more entity data objects within the target repository 402 that store entity data associated with the entity. The entity data objects, for example, may be connected by a common entity identifier for the entity. In addition, or alternatively, the entity data may be stored within a single data object that corresponds to the entity. The entity data may comprise one or more domain-specific attributes for the entity that may be leveraged by the time prediction model pipeline 408 to generate one or more entity-level and/or entity cluster-level predictions for the target repository 402. In a healthcare example, the attributes may comprise demographic information, clinical risk scores, clinical visit history, and/or the like. In another, computer infrastructure domain, the attributes may comprise application execution times, data schemas, communication protocols, and/or the like. In any domain, the entity attributes may be stored as unstructured (e.g., natural language, image data, audio data) and/or structured data within the one or more entity data objects. By way of example, in the structured data example, the provider attributes may be stored as separate database fields, and/or the like.

In some examples, the set of entities 404 associated with a target repository 402 may comprise a set of individual processing instances for the optimization task. This allows the computing system 101 to efficiently process large numbers of entities using object-oriented programming techniques as entity objects may be passed between different components of the system for analysis and optimization. To address large numbers (e.g., thousands, millions) of entities, traditional optimization tasks may summarize the set of entities 404 with overarching themes that increase the speed of the optimization task at the cost of accuracy. The parallel machine learning optimization pipeline 400 improves upon such techniques by processing the set of entities 404 in parallel with a set of providers 406 in separate prediction pipelines that themselves may be executed in parallel.

In some embodiments, a provider of the set of providers 406 is a unit of information that provides a capacity for an allocation of time within an observation time period optimized by the optimization task. A provider may depend on the optimization task. For example, the provider may comprise a healthcare provider (e.g., a physician, advanced practice clinicians, or other medical professionals) in a healthcare panel optimization task, a computing component (e.g., memory, processor) in a processing optimization task, and/or the like. In any domain, a provider may represent a unit that provides time capacity within an observation time period in the context of resource allocation and optimization. In the healthcare example, for instance, the healthcare provider may correspond to a person that provides healthcare services over the observation time period. In the computing ecosystem example, the entity may correspond to a computing component that provides processing, memory, and/or any other computing resources over the observation time period.

In some examples, a provider may correspond to one or more provider data objects within the target repository 402 that store provider data associated with the provider. The provider data objects, for example, may be connected by a common provider identifier (e.g., natural provider identifier) for the provider. In addition, or alternatively, the provider data may be stored within a single data object that corresponds to the provider. The provider data may comprise one or more domain-specific attributes for the provider that may be leveraged by the capacity prediction model pipeline 410 to generate one or more provider-level predictions for the target repository 402. In a healthcare example, the attributes may comprise specialty, work schedule, historical productivity data, and/or the like. In another, computer infrastructure domain, the attributes may comprise architecture data (e.g., number of cores, chips), resource allocations (e.g., allocated space on a shared server), and/or the like. In any domain, the provider attributes may be stored as unstructured (e.g., natural language, image data, audio data) and/or structured data within the one or more provider data objects. By way of example, in the structured data example, the provider attributes may be stored separate database fields, and/or the like.

In some examples, the set of providers 406 associated with a target repository 402 may comprise a set of individual processing instances for the optimization task. This allows the computing system 101 to efficiently process large numbers of providers using object-oriented programming techniques as provider objects may be passed between different components of the system for analysis and optimization. To address large numbers (e.g., thousands, millions) of providers, traditional optimization tasks may summary the set or providers 406 with overarching themes that increase the speed of the optimization task at the cost of accuracy. The parallel machine learning optimization pipeline 400 improves upon such techniques by processing the set of providers 406 in parallel with a set of entities 404 in separate prediction pipelines that themselves may be executed in parallel.

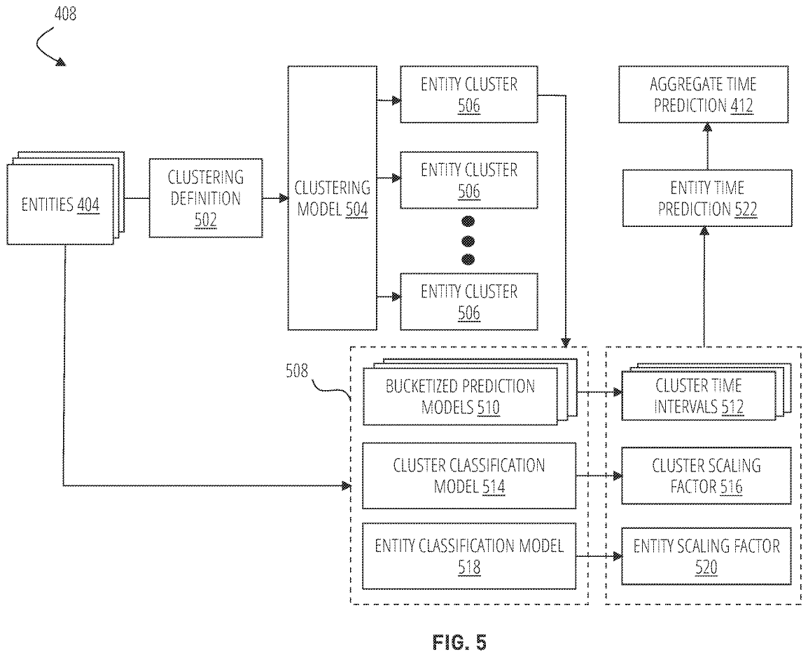

In some embodiments, the computing system 101 generates, using the time prediction model pipeline 408, an aggregate time prediction for the target repository. In some embodiments, the aggregate time prediction 412 comprises an output of the time prediction model pipeline 408 that describes a total time allocation for a set of entities 404. The aggregate time prediction 412, for example, may describe a total time commitment (e.g., “demand”) needed for a target repository 402 (e.g., healthcare panel, computing ecosystem). In some examples, as described herein with reference to FIG. 5, the aggregate time prediction 412 (e.g., Demand_{N}) may comprise an aggregation of entity time predictions for up to each entity of a set of entities 404 (e.g., patients, applications) associated with the target repository 402 (e.g., healthcare panel, computing ecosystem). By way of example, the aggregate time prediction 412 may comprise a summation, weighted summation, statistical aggregations (e.g., mean, median, percentiles), and/or the like of a set of entity time predictions for the set of entities 404 that may be generated in parallel with an aggregate capacity prediction 414.

The aggregate time prediction 412 may comprise single numeric value and/or a set of probabilistic and/or real numbers for a particular observational time period (e.g., breakdowns by time periods, or other relevant categories). In addition, or alternatively, the aggregate time prediction 412 may comprise one or more probabilistic aggregate time predictions, representing the demand as a distribution rather than a single point estimate. This could be achieved through techniques such as Monte Carlo simulations, Bayesian prediction models, and/or the like allowing for more nuanced decision-making that accounts for uncertainty in the predictions. In any data format, the aggregate time prediction 412 may comprise a key input to an optimization process, representing the total expected demand for the target repository 402. By generating the aggregate time prediction 412 in parallel with the aggregate capacity prediction 414, the parallel machine learning optimization pipeline 400 may enable real-time predictions to balance counteracting components of the optimization process.

In some embodiments, the computing system 101 generates, using the capacity prediction model pipeline 410, an aggregate capacity prediction 414 for the target repository 402 based on a set of providers 406 associated with the target repository 402. In some embodiments, aggregate capacity prediction 414 comprises an output of the capacity prediction model pipeline 410 that describes a total time capacity for a set of providers 406. The aggregate capacity prediction 414, for example, may describe a total time availability (e.g., “supply”) for a target repository 402 (e.g., healthcare panel, computing ecosystem). In some examples, as described herein with reference to FIG. 5, the aggregate time prediction 412 (Capacity_{N}) may comprise an aggregation of provider churn predictions for up to each provider of a set of providers 406 (e.g., healthcare providers, computing devices) associated with the target repository 402 (e.g., healthcare panel, computing ecosystem). By way of example, the aggregate capacity prediction 414 may comprise a summation, weighted summation, statistical aggregations (e.g., mean, median, percentiles), and/or the like of a set of provider capacity predictions for the set of providers 406 that may be generated in parallel with the aggregate time prediction 412.

The aggregate capacity prediction 414 may comprise single numeric value and/or a set of probabilistic and/or real numbers for a particular observational time period (e.g., breakdowns by time periods, or other relevant categories). In addition, or alternatively, the aggregate capacity prediction 414 may comprise one or more probabilistic aggregate time predictions, representing the supply as a distribution rather than a single point estimate. This could be achieved through techniques such as Monte Carlo simulations, Bayesian prediction models, and/or the like allowing for more nuanced decision-making that accounts for uncertainty in the predictions. In any data format, the aggregate capacity prediction 414 may comprise a key input to an optimization process, representing the total expected supply for the target repository 402. By generating the aggregate capacity prediction 414 in parallel with the aggregate time prediction 412, the parallel machine learning optimization pipeline 400 may enable real-time predictions to balance counteracting components of the optimization process.

In some embodiments, the computing system 101 synthesizes the aggregate time prediction 412 and the aggregate capacity prediction 414 to generate a utilization indication 418 for the target repository 402. The aggregate time prediction 412, for example, may comprise a first real number and the aggregate capacity prediction 416 may comprise a second real number. The computing system 101 may determine a time capacity ratio 416 by (i) subtracting the aggregate time prediction 412 from the aggregate capacity prediction 414 to determine a third real number, i.e., a capacity utilization and (ii) dividing the capacity utilization by the aggregate capacity prediction 414 to determine the time capacity ratio 416. The computing system 101 may generate the utilization indication 418 from a set of optimization categories based on the time capacity ratio 416.

In some embodiments, time capacity ratio 416 comprises a ratio between the aggregate time prediction 412 and the aggregate capacity prediction 414. The time capacity ratio 416 represents a quantitative measure of the balance between predicted time requirements and the available capacity for a target repository 402 (e.g., healthcare panel, computing ecosystem) over an observation time period. The time capacity ratio 416, for example, may be determined by comparing two key outputs, the aggregate time prediction 412 (e.g., predicted time requirements) and/or the aggregate capacity prediction 414 (e.g., predictive capacity requirements), respectively generated by parallel processing streams of the parallel machine learning optimization pipeline 400 (e.g., the time prediction model pipeline 408 and capacity prediction model pipeline 410). In some examples, the time capacity ratio 416 may be determined by subtracting the aggregate time prediction 412 from the aggregate capacity prediction 414 to determine a capacity utilization value and then dividing the capacity utilization value by the aggregate capacity prediction 414 to normalize the result. By way of example, the time capacity ratio 416 may be determined by:

time capacity ratio=(Demand_{N}−Capacity_{N})/(Capacity_{N})

In some examples, the time capacity ratio 416 is a standardized metric that may be used to assess a utilization level of a target repository 402 relative to other repositories. In this manner, the computing system 101 may leverage the time capacity ratio 416 to determine a categorical value, such as the utilization indication 418 for the target repository 402 that describes the relative utilization of the target repository 402. In addition, or alternatively, the time capacity ratio 416 may be directly comparable to other ratios previously generated for the target repository 402 and/or for comparable repositories to track changes in utilization over time and/or across different data repositories, regardless of a number of entities or providers represented within a repository. In this way, the time capacity ratio 416 comprises a normalized metric that enables direct comparisons across time and/or data repositories.

In some embodiments, utilization indication 418 comprises a categorical value assigned to a target repository 402 based on the aggregate time prediction 412, the aggregate capacity prediction 414, and/or time capacity ratio 416. In some examples, utilization indication 418 may comprise one of set of optimization categories that describe a relative utilization of the target repository 402. The utilization indication 418, for example, may be determined from the set of optimization categories based on the time capacity ratio 416. For example, the set of optimization categories may comprise one or more underutilization categories (e.g., highly overutilized, overutilized), one or more overutilization categories (e.g., highly underutilized, underutilized), and/or one or more optimal categories.

In some examples, the computing system 101 may generate the utilization indication 418 by mapping the time capacity ratio 416 to predefined categories using threshold values and/or classification algorithms. For example, the utilization indication 418 may be represented as an enumerated type and/or categorical variable (e.g., highly overutilized category, overutilized category, highly underutilized category, underutilized category). The computing system 101 may generate the utilization indication 418 using conditional logic and/or a lookup table to map the time capacity ratio 416 to a particular enumerated type and/or categorical variable. By way of example, the computing system 101 may assign an utilization indication 418 as a highly overutilized category if the time capacity ratio 416 is >0.2 (or 20% time shortage), an overutilized category if the time capacity ratio 416 is >0.1 (or 10% time shortage), a highly underutilized category if the time capacity ratio 416 is <−0.2 (or 20% time surplus), an underutilized category if the time capacity ratio 416 is <−0.1 (or 10% time surplus), and/or optimal otherwise.

In this manner, the utilization indication 418 may provide an actionable value for a target repository that may trigger appropriate responses and/or interventions to address imbalances between counteracting predictions (e.g., aggregate time prediction 412, aggregate capacity prediction 414). For example, one of the “overutilization” categories may prompt actions to reduce entity load and/or increase provider capacity, while one of the “underutilization” categories may prompt efforts to add more entities and/or lend providers to other repositories (e.g., to equally distribute application performance across a computing ecosystem).

In some embodiments, the computing system 101 initiates a performance of a prediction-based action based on the utilization indication 418. For example, responsive to a first determination that the utilization indication 418 corresponds to an overutilization category, the computing system 101 may divert an entity from the target repository 402. In addition, or alternatively, responsive to a second determination that the utilization indication corresponds to an underutilization category, the computing system 101 may divert an entity to the target repository 402.

In some embodiments, the computing system 101 determines a loss value based on the aggregate time prediction 412 and/or the aggregate capacity prediction 414. The computing system 101 may determine a threshold entity limit 420 based on the loss value and/or output the threshold entity limit 420 with the utilization indication 418. The loss value, for example, may comprise an absolute value between the aggregate time prediction 412 and the aggregate capacity prediction 414. For instance, the loss value may be defined as:

Loss_{N}=|Demand_{N}−Capacity_{N}

The loss value may represent a measure of a difference between two counteracting predictions (e.g., the aggregate time prediction 412 and aggregate capacity prediction 414) for an optimization task designed to reduce the difference. Thus, the loss value is designed to assess the overall efficiency of resource allocation within a target repository 402 and to measure the performance of the optimization task for the target repository 402. A larger loss value indicates a greater mismatch between the aggregate time prediction 412 and aggregate capacity prediction 414 that may inform adjustments by the optimization task to achieve balance. In some examples, the loss value may be used to define a threshold entity limit 420 by iteratively adjusting (e.g., adding synthetic entities/providers or removing current entities/providers) a number of the set of entities 404 and/or the set of providers 406 within the target repository 402 to lower the loss value.

In some embodiments, the threshold entity limit 420 defines a maximum capacity of a target repository 402 that is determined by minimizing a loss value through one or more iterations of the parallel machine learning optimization pipeline 400. The threshold entity limit 420, for example, may represent an upper bound on the number of entities 404 (e.g., patients, application) that may be effectively managed, run, processed, and/or the like by a set of providers 406 within a target repository 402 (e.g., healthcare panel, computing ecosystem). For example, the computing system 101 may iteratively adjust the threshold entity limit 420 by adding synthetic entities to the set of entities and/or removing entities from the set of entities to find an optimal limit that minimizes the loss value while satisfying other constraints. The synthetic entities, for example, may comprise duplicates and/or random variations of entities sampled from the set of entities and/or entities from one or more other data repositories.

The resulting threshold entity limit 420 may be stored as an integer value representing the maximum number of entities with respect to a target repository 402. In this manner, the threshold entity limit 420 may provide guidance for repository management and resource allocation. For example, by establishing a maximum capacity based on predictive modeling, the computing system 101 may make informed decisions with respect to future entity assignment (e.g., downloading a new application, assigning a new patient), provider assignment (e.g., obtaining more server space, provider recruitment), and/or overall repository size management.

FIG. 5 depicts a dataflow diagram of a time prediction model pipeline 408 in accordance with some embodiments of the present disclosure. As depicted, the time prediction model pipeline 408 combines a unique set of model architectures, such as the clustering model 504, the bucket-specific prediction models 510, and classification models (e.g., cluster classification model 514, utilization indication 418), to forecast a prediction for up to each entity within a set of entities 404 that combines insights from several aspects of a timing prediction into a single predictive unit that is more easily handled (e.g., transmittable, storable, combinable) within a computing environment. By doing so, the time prediction model pipeline 408 may improve the accuracy of temporal predictions at an entity level, which, in turn, may improve predictions (e.g., in terms of accuracy) for a set of entities 404 as a whole.

In some embodiments, the computing system 101 generates, using a clustering model 504 of the time prediction model pipeline 408, a group of entity clusters 506 from the set of entities 404 associated with the target repository 402. In some examples, the group of entity clusters 506 may be based on a clustering definition 502 that defines one or more grouping attributes for the set of entities 404.

In some embodiments, the clustering model 504 comprises an initial model of the time prediction model pipeline 408 that clusters entities into different entity clusters 506 for subsequent operations of the time prediction model pipeline 408. The clustering model 504 may comprise a rule-based and/or machine learning clustering technique. For instance, the clustering model 504 may comprise an unsupervised machine learning model designed to group similar entities together based on their attributes such as a k-means model, hierarchical clustering model, DBSCAN model, and/or the like. The clustering model 504 may receive entity attribute data, and/or a subset thereof (e.g., as defined by the clustering definition 502), as input and produce cluster assignments as output. This may comprise converting the entity attribute data to a high-dimensional (and/or low-dimensional) feature space, calculating distances (e.g., cosine distances, Euclidean distances, Manhattan distances) and/or similarities between entities in the feature space, and iteratively clustering the entities into different entity clusters 506 based on their distances. In some examples, the clustering model 504 may be run iteratively to refine the cluster assignments until a stable grouping is achieved.

In some embodiments, the clustering definition 502 identifies a subset of entity attributes for use by the clustering model 504 in clustering a set of entities. The clustering definition 502 may be based on the optimization task. For instance, in a healthcare panel optimization task, the clustering definition 502 may define a subset of entity attributes that are reflective of a patient complexity. Those may comprise a demographic attributes (e.g., age-group, gender, ethnicity), risk level attributes (e.g., comorbidity risk of patients, such as Cranial Cervical Instability, Elixhauser, Hierarchical Condition Categories), payer mix (e.g., patient's yearly plan, such as Medicare), establishment status (e.g., new or established), payer class (e.g., patient payment model, such as full-risk, shared-risk), behavioral health issues, and/or the like. As another example, in a processing optimization task, the clustering definition 502 may define a subset of entity attributes that are reflective of an application complexity, such as application size, memory requirements, and/or the like.

The clustering definition 502 may be implemented as a configuration and/or parameter set. This may be represented as a list, array of attribute names, or as a more complex data structure that comprises additional information about how each attribute should be processed or weighted by the clustering model 504. In some examples, the clustering definition 502 may be stored as a configuration file (e.g., JSON, YAML), as a database record, and/or the like, to enable modification of the clustering criteria without changing the underlying functionality of the time prediction model pipeline 408. In this manner, the time prediction model pipeline 408 may be configurable for different prediction domains by modifying the clustering definition 502.

In some embodiments, an entity cluster of the group of entity clusters 506 comprises a set of related entities, as defined by a clustering model 504 using a clustering definition 502. An entity cluster, for example, may comprise a cluster output by the clustering model 504 that comprises a subset of the set of entities 404 associated with a target repository. In the optimization scenario of the present disclosure, an entity cluster may represent a subset of entities that are expected to have comparable time requirements (e.g., patient personas with similar patient complexities a healthcare domain, application personas with similar processing requirements for computing infrastructure domain). The entity cluster may be represented as a data structure containing references and/or identifiers for the subset of entities belonging to that cluster. This may comprise an array, list, set data structure, and/or the like. In addition, or alternatively, the entity cluster may comprise associated metadata, such as a centroid, representative entity, summary statistics of the cluster's attributes, and/or other derived features for the entity cluster.

In some embodiments, the computing system 101 generates an aggregate time prediction 412 for the set of entities 404 using the group of entity clusters 506 and/or a first staged prediction model 508 of the time prediction model pipeline 408. The first staged prediction model 508, for example, may comprise a configuration of machine models following the clustering model 504 within the time prediction model pipeline 408 that is configured to generate component predictions of an aggregate time prediction 412. When executed, the first staged prediction model 508 may implement a multi-stage predictive process for generating and then aggregating a set of time predictions, at an entity level, for an entity of the set of entities 404 to holistically forecast an entity time prediction 522 for up to each entity of the set of entities 404.

The first staged prediction model 508 may comprise a series of interconnected machine learning models that each focus on a specific aspect of the time prediction task. To further improve prediction speeds of the computing system 101 (and thereby enable real time predictions), up to each of the interconnected machine learning models may be executed in parallel. In addition, or alternatively, one or more of the set of interconnected models may be executed in sequence to enable composite predictions that build on predictions of earlier models within the sequence. In either case, the series of interconnected machine learning models may comprise one or more different architectures that are specialized for a particular aspect of the time prediction task. For instance, the series of interconnected machine learning models may comprise regression models (e.g., linear regression, random forests, gradient boosting machines, logistic regression, support vector machines) for predicting continuous time values, classification models (e.g., neural networks, support vector machines) for predicting binary and/or categorical outcomes related to time requirements, and/or the like.

The first staged prediction model 508 may comprise routing and/or execution logic for executing one or more of the series of interconnected machine learning models with respect to different portions of entity data. For instance, the first staged prediction model 508 may route cluster entity data (e.g., comprising entity attributes for up to each entity within an entity cluster), individual entity data (e.g., comprising entity attributes for a single entity within an entity cluster), and/or different combinations thereof to up to each of the series of interconnected machine learning models. By way of examples, the first staged prediction model 508 may route cluster entity data to a set of bucket-specific prediction models 510 and/or a cluster classification model 514 to generate cluster level predictions (e.g., cluster time intervals 512, cluster scaling factor 516) for an entity of the set of entities 404. In addition, or alternatively, the first staged prediction model 508 may route individual entity data to an entity classification model 518 to generate entity-level predictions (e.g., entity scaling factors 520) for the entity. In this manner, the first staged prediction model 508 may combine abstractive predictions (e.g., at a cluster level) with individualize predictions to generate an entity time prediction 522 in a manner that balances speed without reductions in accuracy. These benefits are further realized by breaking down a complex, multi-faceted prediction into manageable sub-problems through the generation of a set of component predictions (e.g., cluster time interval 512, cluster scaling factor 516, entity scaling factor 520) that may be combined to achieve a single prediction with increased accuracy compared to monolithic prediction techniques.

In some embodiments, the computing system 101 generates, at a first stage, a set of cluster time intervals 512 for an entity cluster 506 of the group of entity clusters. In some examples, the set of cluster time intervals 512 comprises a cluster time interval that corresponds to a defined prediction bucket (e.g., bin) of a set of defined prediction buckets. In some examples, up to each of the set of defined prediction buckets may correspond to a different time interval. The computing system 101 may aggregate the set of cluster time intervals 512 to generate an aggregated entity time interval for an entity of the set of entities 404.

In some embodiments, a cluster time interval 512 comprises a cluster-level time prediction for an entity cluster with respect to a defined prediction buckets. The defined prediction buckets, for example, may correspond to a type of time expense, such as a type of clinical visit, a type of application execution, and/or the like, that is reflective of a different amount of time for a particular event. In some examples, the cluster time interval 512 may indicate a predicted number of events, a total time requirement from the predicted number of events, and/or the like, for an entity cluster (e.g., at an entity level or cluster level) of a defined prediction buckets over an observation time period. In some examples, the computing system 101 may generate a cluster time interval 512 for up to each of the set of defined prediction buckets. In this way, the cluster time intervals 512 may comprise a set of individual time predictions for an entity that is derived from the cluster within which the entity belongs and is reflective of a forecasted amount of time over an observational time period for up to each of a set of event types associated with an optimization task.

By breaking up the predictions at a cluster and defined prediction buckets pair level, the first staged prediction model 508 enables improved predictive accuracy of machine learning techniques applied in complex forecasting domains. For example, up to each of the set of cluster time intervals 512 may be generated by a machine learning model (e.g., bucket-specific prediction models 510) that is fitted to, trained on, and/or otherwise configured using historical data for a particular combination of entity cluster and/or defined prediction buckets. As described with respect to the bucket-specific prediction models 510, the reduction in scope of the cluster time intervals 512 enables more varied model architectures, such a time-series regression models, that excel at temporal predictions.

In some examples, a set of cluster time interval 512 may be generated, in parallel and/or in series, with one or more other predictions of the time prediction model pipeline 408. In some examples, the set of cluster time intervals 512 may be generated as a preprocessing step before the generation of entity-level predictions for up to each entity of the set of entities 404. For instance, the set of cluster time intervals 512 may be generated for up to each of a set of bucket-cluster pairs after the group of entity clusters 506 are determined from the set of entities 404. The set of cluster time intervals 512 may be stored in a lookup table (e.g., as multi-dimensional array or matrix, with dimensions corresponding to entity clusters and/or defined prediction bucket) for efficient storage and/or retrieval of the predictions as up to each entity-level iteration of the time prediction model pipeline 408. By way of example, a subset of cluster time intervals 512 may serve as base predictions for an entity time prediction 522 at up to each of a set of iterations respectively performed for up to each of the set of entities 404.

In some embodiments, at a particular entity-level iteration of the time prediction model pipeline 408, an aggregated entity cluster time interval is generated for an entity based on a subset of the cluster time intervals 512 that correspond to the cluster within which the entity is assigned. For example, the aggregated entity cluster time interval may comprise an aggregation (e.g., summation, weighted summation, statistical aggregations (e.g., mean, median, percentiles)) of a cluster time interval for the entity cluster and up to each of a set of defined prediction buckets. By way of example, the aggregated entity cluster time interval may be defined as:

(Demandₛₕₒᵣₜ(c)+Demand_{medium}(c)+Demand_{long}(c))

where Demandₛₕₒᵣₜ, Demand_{medium}, Demand_{long} correspond to defined prediction buckets and c corresponds to a particular entity cluster.

In some embodiments, the time prediction model pipeline 408 comprises a set of bucket-specific prediction models 510 that is respectively configured to generate the set of cluster time intervals 512. The set of bucket-specific prediction models may comprise a regression model for up to each of a set of bucket-cluster pairs. For instance, a bucket-specific regression model may correspond to a bucket-cluster pair that comprises the entity cluster of the group of entity clusters 506 and a defined prediction bucket of a set of defined prediction buckets. By way of example, bucket-specific regression model may comprise a regression model that is trained, configured, and/or the like using data corresponding to a bucket-cluster pair. In this way, a different regression model may be specialized for up to each bucker-cluster pair within the set of bucket-cluster pairs.

In some embodiments, a bucketized prediction models 510 comprises machine learning model that is trained, fit to, and/or otherwise configured for a distribution of data for a pair of an entity cluster and a defined prediction bucket. The bucketized prediction models 510, for example, may comprise a time-series forecast model that may be fitted using historical cluster entity data specific to an entity cluster and a defined prediction bucket. The time-series forecast model, for example, may comprise a regression model, such as a linear regression model, that is trained using historical attribute data, at a cluster level, as independent parameters for a dependent parameter reflective of a historical time interval from historical events corresponding to a particular defined prediction bucket. The bucketized prediction model 510, for example, may be trained, using back propagation of errors as optimized using gradient descent, to minimize a loss functions, such as mean squared error, and/or the like. The loss function, for example, may measure a difference between a time interval forecasted based on historical attribute data for an entity cluster and a historical time interval recorded for the entity cluster with respect to a particular defined prediction bucket.

In some examples, a separate bucketized prediction model may be configured for up to each bucket-cluster pair to form a set of specialized regression models for several stratifications of a set of entities 404. The bucketized prediction models 510 may be implemented as a collection of machine learning regression models, up to each trained on a specific subset of historical data corresponding to a particular entity cluster and prediction bucket. When implemented in a computer system, bucketized prediction models 510 may be organized as a two-dimensional array, dictionary, with keys or indices corresponding to entity clusters and prediction buckets, and/or the like, to enable the execution of the bucketized prediction models 510 for up to each of the set of entity clusters 506 using real time data. In this way, the bucketized prediction models 510 may be leveraged to generate highly specific time predictions tailored to particular combinations of entity characteristics (represented by clusters) and temporal categories (represented by buckets) to better capture nuanced patterns and relationships that may be missed by more general models.

In some embodiments, the defined prediction bucket is a data entity that defines a category of time predictions associated with one or more events of a unit of time. The defined prediction buckets, for example, may depend on the prediction domain and/or optimization task. By way of example, in a healthcare optimization task, the defined prediction buckets may define clinical visit types, such as long visit types (e.g., ninety minutes), short visit types (e.g., thirty minutes), medium visit types (e.g., sixty minutes), and/or the like. In a processing optimization task, the defined prediction buckets may define processing types, such as long processing task types (e.g., ninety minutes), short processing task types (e.g., thirty minutes), medium processing task types (e.g., sixty minutes), and/or the like. In any domain, a set of defined prediction buckets may represent discrete categories used to classify and/or predict different types of time requirements for a target repository 402.

The set of defined prediction buckets may be defined to simplify a complex continuum of possible time requirements into manageable, discrete categories to improve the efficiency of machine techniques applied by the time prediction model pipeline 408. This allows for more efficient modeling and interpretation of predictions, as well as easier integration with real time optimization techniques that may operate on fixed time slot durations.

In some embodiments, the computing system 101 generates, at a second stage, one or more scaling factors for the set of cluster time intervals 512. For example, the computing system 101 may generate an entity scaling factor 520 for an entity of the entity cluster 506. In addition, or alternatively, the computing system 101 may generate a cluster scaling factor 516 for an entity of the entity cluster 506. In some examples, the entity scaling factor 520 may be generated using an entity classification model 518 and/or the cluster scaling factor 516 may be generated using a cluster classification model 514.

In some embodiments, the entity scaling factor 520 comprises an entity-level coefficient used to scale cluster-based predictions for an entity. The entity scaling factor 520 may comprise a prediction uncertainty value for an entity that is based on a set of entity attributes of the entity. The entity scaling factor 520, for example, may comprise a probabilistic value that is output by an entity classification model 518 based on the individual attributes of an entity within the set of entities 404. The entity scaling factor 520, for example, may be generated by a machine learning classification model trained to predict entity-specific adjustments to cluster-level predictions. The entity-specific adjustments, for example, may be based on a probability of an event, such as a churn event in which an entity may leave and/or be removed from a target repository. In this manner, the entity scaling factor 520 may be used to incorporate an uncertainty to the temporal predictions of an entity that account for unique characteristics, behaviors, and/or the like that may influence their time requirements. This allows the system to balance the efficiency of cluster-based predictions with the accuracy of individualized adjustments.

In some embodiments, the entity classification model 518 comprises a machine learning model that is trained, fit to, and/or otherwise configured for an entity-level distribution of data and a target prediction. The entity classification model 518, for example, may comprise a machine learned classifier, such as a binary classifier, multi-label classifier, and/or the like, for one or more target predictions. The one or more target predictions may depend on the prediction domain. In some examples, the target predictions may comprise a churn prediction that predicts whether an entity will leave the target repository. In such a case, the entity classification model 518 may output a probabilistic value that reflects a likelihood that an entity will leave a target repository (and thus not contribute to the time requirements of the target repository). By way of example, the entity classification model 518 may comprise a binary classification model configured (e.g., trained) to generate a churn prediction based on a set of entity attributes. The set of entity attributes may be the same and/or different from the set of entity attributes used to cluster the entity.

In some examples, the entity classification model 518 may comprise a supervised machine learning classifier that is trained on historical data to predict a binary outcome (e.g., churn). The supervised machine learning classifier may comprise one or more neural networks, support vector machines, and/or the like. In some examples, the entity classification model 518 may be trained, using a backpropagation of errors as optimized using gradient descent, using a labelled training dataset that comprises a set of attribute-prediction pairs. Up to each of the set of attribute-prediction pairs may comprise a set of entity attributes and a classification label (e.g., binary label, multi-category label) for a target prediction. The entity classification model 518 may be trained by minimizing a classification loss function, such a binary cross-entropy loss, log loss, and/or the like. In this manner, the entity classification model 518 may be trained to generate entity-specific predictions that may be used to adjust and/or interpret other predictions in the system. In the case of a churn prediction model, for example, the output may be used to adjust time predictions based on the likelihood of an entity remaining in the target repository.

In some embodiments, the cluster scaling factor 516 comprises a cluster-level coefficient used to scale the cluster- and entity-based predictions for an entity. The cluster scaling factor 516, for example, may comprise a cluster-level coefficient used to scale cluster-based predictions for an entity. The cluster scaling factor 516 may comprise a probabilistic value that is output by cluster classification model 514 based on cluster entity data for an entity cluster and the target repository at a particular point in time. The cluster scaling factor 516, for example, may be generated by a machine learning classification model trained to predict cluster-specific adjustments to cluster-level predictions. The cluster-specific adjustments, for example, may be based on a probability of an event, such as a diversion event in which an entity within an entity cluster 506 may be processed using providers from another target repository. In this manner, the cluster scaling factor 516 may be used to incorporate an uncertainty to the temporal predictions of an entity that account for unique cluster-level characteristics, behaviors, and/or the like that may influence time requirements for a particular entity. This allows the system to finetune baseline predictions (e.g., aggregate cluster time interval) using a corrective predictions (e.g., the cluster scaling factor 516) for a particular cluster the focus of different aspects of a temporal prediction.

In some embodiments, the cluster scaling factor 516 is generated by a machine learning model trained to predict adjustments to predictions based on cluster-level attributes of an entity cluster with respect to a target repository. By doing so, the cluster scaling factor 516 may enable adjustments to predictions based on cluster-level trends and/or patterns that may not be captured by individual entity characteristics or initial baseline predictions. This allows the system to account for group-level effects that influence time requirements across multiple entities within a cluster.

In some embodiments, the cluster classification model 514 comprises a machine learning model that is trained, fit to, and/or otherwise configured for a cluster-level distribution of data and a target prediction. The cluster classification model 514, for example, may comprise a machine learned classifier, such as a neural network which is bounded within [0,1] range using sigmoid functions, and/or the like, for one or more target predictions. The one or more target predictions may depend on the prediction domain. In some examples, the target predictions may comprise a diversion prediction that predicts a propensity of a set of providers within a target repository to divert entities of a particular entity cluster. In such a case, the cluster classification model 514 may output a probabilistic value that reflects a predicted rate at which an entity will be diverted from the target repository (and thus contribute less to the time requirements of the target repository).

By way of example, the cluster classification model 514 may comprise a machine learning classifier with a sigmoid activation function to bound the output between 0 and 1. This may be achieved using one or more neural networks with a sigmoid output layer, and/or other algorithms capable of producing bounded predictions. The cluster classification model 514 may be trained on historical data of entity diversion patterns from a target repository. In some examples, the cluster classification model 514 may be trained, using a backpropagation of errors as optimized using gradient descent, using a labelled training dataset that comprises a set of attribute-prediction pairs. Up to each of the set of attribute-prediction pairs may comprise a set of cluster entity attributes and a classification label (e.g., diversion rate label) for a target prediction. The cluster classification model 514 may be trained by minimizing a classification loss function, such a binary cross-entropy loss, log loss, and/or the like. In this manner, the cluster classification model 514 may be trained to generate cluster-specific predictions that may be used to adjust and/or interpret other predictions in the system. In the case of a diversion prediction model, for example, the output may be used to adjust time predictions based on the propensity of an entity to be diverted from the target repository.

In some embodiments, the computing system 101 generates an entity time prediction 522 based on (i) the set of cluster time intervals 512 and/or (ii) one or more of the scaling factors (e.g., entity scaling factor 520, cluster scaling factor 516). In some examples, the entity time prediction 522 may be one of a set of entity time predictions that respectively correspond to the set of entities 404 associated with the target repository 402. For example, the computing system 101 may apply the entity scaling factor 520 and/or the cluster scaling factor 516 to the aggregated entity time interval to generate the entity time prediction 522. By way of example, the entity time prediction 522 may be defined as:

(Demandₛₕₒᵣₜ(c)+Demand_{medium}(c)+Demand_{long}(c))*Diversion(c,N)*Churn(c,p)

where Diversion(c, N) corresponds to the cluster scaling factor 516 and Churn(c, p) corresponds to the entity scaling factor 520.

In some embodiments, the entity time prediction 522 comprises an individual time prediction (e.g., demand) for an entity of the set of entities 404. In some examples, the entity time prediction 522 may comprise one of a set of outputs from the time prediction model pipeline 408 that is generate during one of a set pipeline iterations. By way of example, the time prediction model pipeline 408 may perform an entity-level iteration for up each entity within the set of entities 404 to generate a set of entity time predictions 522 that respectively identify predicted time requirements for the set of entities 404.

In some embodiments, the computing system 101 generates, at a third stage, the aggregate time prediction 412 based on (i) the set of cluster time intervals and (ii) the one or more scaling factors (e.g., entity scaling factor 520, cluster scaling factor 516). For instance, the computing system 101 may generate the aggregate time prediction 412 by aggregating the set of entity time predictions 522. By way of example, the aggregate time prediction 412 may be defined as:

$${Demand}_{N} = {\sum }_{\begin{matrix}p ∈ P \\ c ∈ C\end{matrix}} ( {Demand}_{short} ( c ) + {Demand}_{medium} ( c ) + {Demand}_{long} ( c ) ) * Diversion ( c , N ) * Churn ( c , p )$$

where the demand (e.g., time requirements) of a repository N is being calculated from individual demands (e.g., entity time predictions 522) of all ‘P’ entities in that repository. Entity ‘p’ belongs to ‘c’ cluster. There are total ‘C’ distinct clusters in the target repository (and/or all repositories of the prediction domain. ‘Demand’ is a function of generating number of short, medium, and long visits in 6-months based on which cluster the entity belongs to. ‘Diversion’ is a repository-specific function that determines the propensity of that repository's entity to use providers from other repositories based on which cluster they belong to, and ‘Churn’ is an entity-specific function to determine entity propensity to move from the target repository.

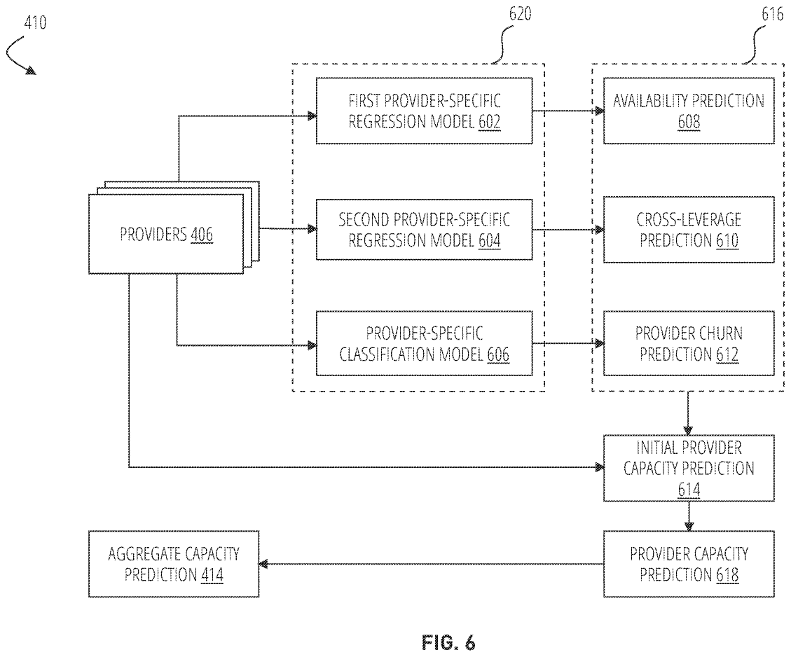

FIG. 6 depicts a dataflow diagram of a capacity prediction model pipeline 410 in accordance with some embodiments of the present disclosure. As depicted, the capacity prediction model pipeline 410 combines a unique set of model architectures, such as the first provider-specific regression model 602, the second provider-specific regression model 604, the provider-specific classification model 606, and/or the like, to forecast a prediction for up to each provider within a set of providers 406 that combines insights from several aspects of a capacity prediction into a single predictive unit that is more easily handled (e.g., transmittable, storable, combinable) within a computing environment. By doing so, the capacity prediction model pipeline 410 may improve the accuracy of capacity predictions at a provider level, which, in turn, may improve predictions (e.g., in terms of accuracy) for a set of providers 406 as a whole.

In some embodiments, the computing system 101 generates an initial provider capacity prediction 614 for a provider of the set of providers 406. In some embodiments, the initial provider capacity prediction 614 is a baseline prediction for a provider based on the type of provider. The initial provider capacity prediction 614, for example, may comprise a starting point for estimating a provider's capacity based on standard expectations for different types of provider within a target repository. In some examples, the initial provider capacity prediction 614 may comprise a statistical aggregation (e.g., mean, median) of historical provider capacities for one or more providers of a particular type. In some examples, the initial provider capacity prediction 614 may be determined from a lookup table, determined using a regression model configured to map provider types to expected capacity values, and/or the like. In this regard, the time prediction model pipeline 408 may receive a provider type as input (e.g., a physician, nurse practitioner, physician assistant in a healthcare example) and output a numeric value (e.g., hours per week, entities per day, or another appropriate unit of capacity) representing the expected baseline capacity for the provider.

In some embodiments, the computing system 101 generates, using a second staged prediction model 620 of the capacity prediction model pipeline 410, a set of correction parameters 616 for the provider. The second staged prediction model 620, for example, may comprise a configuration of machine models following the initial provider capacity prediction 614 within the capacity prediction model pipeline 410 that is configured to generate component predictions of an aggregate capacity prediction 414. When executed, the second staged prediction model 620 may implement a multi-stage predictive process for generating and then aggregating a set of time predictions, at a provider level, for a provider of the set of providers 406 to holistically forecast a provider capacity prediction 618 for up to each provider of the set of providers 406.

The second staged prediction model 620 may comprise a series of interconnected machine learning models that each focus on a specific aspect of the capacity prediction task. To further improve prediction speeds of the computing system 101 (and thereby enable real time predictions), up to each of the interconnected machine learning models may be executed in parallel. In addition, or alternatively, one or more of the set of interconnected models may be executed in sequence to enable composite predictions that build on predictions of earlier models within the sequence. In either case, the series of interconnected machine learning models may comprise one or more different architectures that are specialized for a particular aspect of the capacity prediction task. For instance, the series of interconnected machine learning models may comprise regression models (e.g., linear regression, random forests, gradient boosting machines, logistic regression, support vector machines) for predicting continuous time values, classification models (e.g., neural networks, support vector machines) for predicting binary and/or categorical outcomes related to capacity requirements, and/or the like.

The second staged prediction model 620 may comprise routing and/or execution logic for executing one or more of the series of interconnected machine learning models with respect to different portions of provider data. For instance, the second staged prediction model 620 may route different combinations of provider data to up to each of the series of interconnected machine learning models. In this manner, the second staged prediction model 620 may combine predictions at different stratification levels to generate an aggregate capacity prediction 414 in a manner that balances speed without reductions in accuracy. These benefits are further realized by breaking down a complex, multi-faceted prediction into manageable sub-problems through the generation of a set of component predictions (e.g., initial provider capacity predictions 614 and correction parameters 616) that may be combined to achieve a single prediction with increased accuracy compared to monolithic prediction techniques.

In some embodiments, a correction parameter of the set of correction parameters 616 comprises one of a set of correction coefficients used to adjust a baseline prediction for a particular provider. The correction parameters 616 may comprise an availability prediction 608, a cross-leverage prediction 610, and/or a provider churn prediction 612. These parameters allow for fine-tuning of capacity predictions based on provider-specific factors and/or historical patterns. Up to each of the correction parameters 616 may be generated by separate machine learning models within the capacity prediction model pipeline 410. By doing so, the set of correction parameters 616 may adjust the initial provider capacity prediction 614 to account for individual variations and/or potential changes in capacity due to a set of different variables. For example, by incorporating factors, such as historical availability patterns, cross-repository coverage tendencies, likelihood of leaving the organization, and/or the like, the correction parameters 616 may generate more accurate and nuanced capacity predictions.

In some embodiments, the set of correction parameters 616 comprises one or more of an availability prediction 608, a cross-leverage prediction 610, and/or a provider churn prediction 612. The computing system 101 may generate up to each of the correction parameters 616 using a different machine learning model. For example, the computing system 101 may generate, at a first stage and using a first provider-specific regression model 602 of the second staged prediction model 620, an availability prediction 608.

In some embodiments, the availability prediction 608 is a corrective coefficient that is used to adjust a baseline prediction based on a predicted availability of a provider. The availability prediction 608 may be generated using a first provider-specific regression model 602 that is trained, fitted, and/or otherwise configured based on a provider's historical availability data. The availability prediction 608 aims to capture patterns in a provider's actual time availability that may deviate from their standard schedule.

In some embodiments, the first provider-specific regression model 602 is a machine learning model that is trained to generate an availability prediction 608 for a particular provider. The first provider-specific regression model 602, for example, may be trained using historical data for the provider that is reflective of the provider's availability. In some examples, the first provider-specific regression model 602 may be implemented as a supervised machine learning model trained on historical data specific to an individual provider. For example, the first provider-specific regression model 602 may comprise linear regression, random forests, support vector regression, and/or the like. In some examples, the first provider-specific regression model 602 may comprise a regression model, such as a linear regression model, random forests, gradient boosting machines, and/or the like, that is trained using historical attribute data, at a provider level, as independent parameters for a dependent parameter reflective of an availability of the provider. The first provider-specific regression model 602, for example, may be trained, using back propagation of errors as optimized using gradient descent, to minimize a loss function, such as mean squared error, and/or the like. The loss function, for example, may measure a difference between an availability forecasted based on historical attribute data for a provider and an availability recorded for the provider. The availability, for example, may be measured by a numerical value that reflects a number (and/or specific time periods) of hours, days, weeks, and/or the like, and/or a ratio of thereof, in which a provider is available and/or unavailable during an observational time period.

In this manner, the first provider-specific regression model 602 may be trained to capture individual patterns in provider availability that may not be reflected by baseline metrics for a group of providers. By training a separate model for each provider, the capacity prediction model pipeline 410 may account for unique work habits, preferences, and/or constraints that impact availability.

In addition, or alternatively, the computing system 101 may generate, at a second stage and using a second provider-specific regression model 604 of the second staged prediction model 620, a cross-leverage prediction 610.

In some embodiments, the cross-leverage prediction 610 is a corrective coefficient that is used to adjust a baseline prediction based on a cross-leverage propensity of a provider. The cross-leverage prediction 610 may be generated using a second provider-specific regression model 604 that is trained, fitted, and/or otherwise configured based on a provider's historical cross-leverage data. The cross-leverage prediction 610 aims to capture cross-leverage patterns of a provider that may impact an actual capacity of a provider for a particular target repository.

In some embodiments, the second provider-specific regression model 604 is a machine learning model that is trained to generate a cross-leverage prediction 610 for a particular provider. The second provider-specific regression model 604, for example, may be trained using historical data for the provider that is reflective of the provider's cross-leverage propensity. In some examples, the second provider-specific regression model 604 may be implemented as a supervised machine learning model trained on historical data specific to an individual provider. For example, the second provider-specific regression model 604 may comprise linear regression, random forests, support vector regression, and/or the like. In some examples, the second provider-specific regression model 604 may comprise a regression model, such as a linear regression model, random forests, gradient boosting machines, and/or the like, that is trained using historical attribute data, at a provider level, as independent parameters for a dependent parameter reflective of a cross-leverage propensity of the provider. The second provider-specific regression model 604, for example, may be trained, using back propagation of errors as optimized using gradient descent, to minimize a loss function, such as mean squared error, and/or the like. The loss function, for example, may measure a difference between a cross-leveraging rate forecasted based on historical attribute data for a provider and a cross-leveraging rate recorded for the provider. The cross-leveraging rate, for example, may be measured by a numerical value that reflects a number (and/or specific time periods) of hours, days, weeks, and/or the like, and/or a ratio of thereof, in which a provider is cross-leveraged to other repositories during an observational time period.

In this manner, the second provider-specific regression model 604 may be trained to capture individual patterns in provider cross-leverage rates that may not be reflected by baseline metrics for a group of providers. By training a separate model for each provider, the capacity prediction model pipeline 410 may account for unique work habits, preferences, and/or constraints that impact availability.

In addition, or alternatively, the computing system 101 may generate, at a third stage and using a provider-specific classification model 606 of the second staged prediction model 620, a provider churn prediction 612. In some embodiments, the provider churn prediction 612 is a corrective coefficient that is used to adjust a baseline prediction based on a churn likelihood of a provider. The provider churn prediction 612 for example, may comprise a probabilistic value that is output by a provider-specific classification model 606 based on the individual attributes of a provider within the set of providers 406. The provider churn prediction 612, for example, may be generated by a machine learning classification model trained to predict provider-specific adjustments to the initial provider capacity prediction 614. The provider-specific adjustments, for example, may be based on a probability of an event, such as a churn event in which a provider may leave and/or be removed from a target repository.

In some embodiments, the provider-specific classification model 606 comprises a machine learning model that is trained, fit to, and/or otherwise configured for a provider-level distribution of data with respect to a target prediction. The provider-specific classification model 606, for example, may comprise a machine learned classifier, such as a binary classifier, multi-label classifier, and/or the like, for one or more target predictions. The one or more target predictions may depend on the prediction domain. In some examples, the target predictions may comprise a churn prediction that predicts whether a provider will leave the target repository. In such a case, the provider-specific classification model 606 may output a probabilistic value that reflects a likelihood that a provider will leave a target repository (and thus not contribute to the time capacity of the target repository). By way of example, the provider-specific classification model 606 may comprise a binary classification model configured (e.g., trained) to generate a churn prediction model based on a set of provider attributes. The set of provider attributes may be the same and/or different from the set of provider attributes used by the first and/or second first provider-specific regression models.

In some examples, the provider-specific classification model 606 may comprise a supervised machine learning classifier that is trained on historical data to predict a binary outcome (e.g., churn). The supervised machine learning classifier may comprise one or more neural networks, support vector machines, and/or the like. In some examples, the provider-specific classification model 606 may be trained, using a backpropagation of errors as optimized using gradient descent, using a labelled training dataset that comprises a set of attribute-prediction pairs. Up to each of the set of attribute-prediction pairs may comprise a set of provider attributes and a classification label (e.g., binary label, multi-category label) for a target prediction. The provider-specific classification model 606 may be trained by minimizing a classification loss function, such a binary cross-entropy loss, log loss, and/or the like. In this manner, the provider-specific classification model 606 may be trained to generate provider-specific predictions that may be used to adjust and/or interpret other predictions in the system. In the case of a churn prediction model, for example, the output may be used to adjust capacity predictions based on the likelihood of a provider remaining in the target repository.

In some embodiments, the computing system 101 synthesizes the initial provider capacity prediction 614 with the set of correction parameters 616 to generate the aggregate capacity prediction 414. For instance, the computing system 101 may generate a provider capacity prediction 618 for a provider of the set of providers 406 by synthesizing the initial provider capacity prediction 614 with the set of correction parameters 616 for the provider. By way of example, the provider capacity prediction 618 may be defined as:

Target(t)*FTE(q,t)*(1−CL(q,N))*Availability(q)*(1−Churn(q))

In some embodiments, the provider capacity prediction 618 comprises an individual time prediction (e.g., supply) for a provider of the set of providers 406. In some examples, the provider capacity prediction 618 may comprise one of a set of outputs from the capacity prediction model pipeline 410 that is generated during one of a set pipeline iterations. By way of example, the capacity prediction model pipeline 410 may perform a provider-level iteration for up each provider within the set of providers 406 to generate a set of provider capacity prediction 618 that respectively identify predicted time capacities for the set of providers 406.

The computing system 101 may generate the aggregate capacity prediction 414 by aggregating a provider capacity prediction 618 for up to each of the set of providers 406. For instance, the computing system 101 may generate the aggregate time prediction 412 by aggregating the set of provider capacity predictions 618. By way of example, the aggregate capacity prediction 414 may be defined as:

$${Capacity}_{N} = {\sum }_{\begin{matrix}q ∈ Q \\ t ∈ ( Phys , APR )\end{matrix}} Target ( t ) * FTE ( q , t ) * ( 1 - CL ( q , N ) ) * Availability ( q ) * ( 1 - Churn ( q ) )$$

where the capacity of target repository N is being calculated from individual capacities of all ‘Q’ providers in that repository. Provider ‘q’ belongs to ‘t’ provider-type, and, in a healthcare example, may be either a physician, physician assistant, or nurse practitioner. ‘Target’ is a type based responsibility of a providers which depends only on their type. ‘FTE’ determines full-time equivalence of the provider ‘q’. ‘Availability’ is a complex function that determines availability of provider ‘q’ based on historic leaves availed and days active during the week. ‘CL’ is proportion of provider's time/effort being cross leveraged to entities from other repositories. ‘Churn’ is a provider-specific function to determine provider's propensity to move out of the target repository.

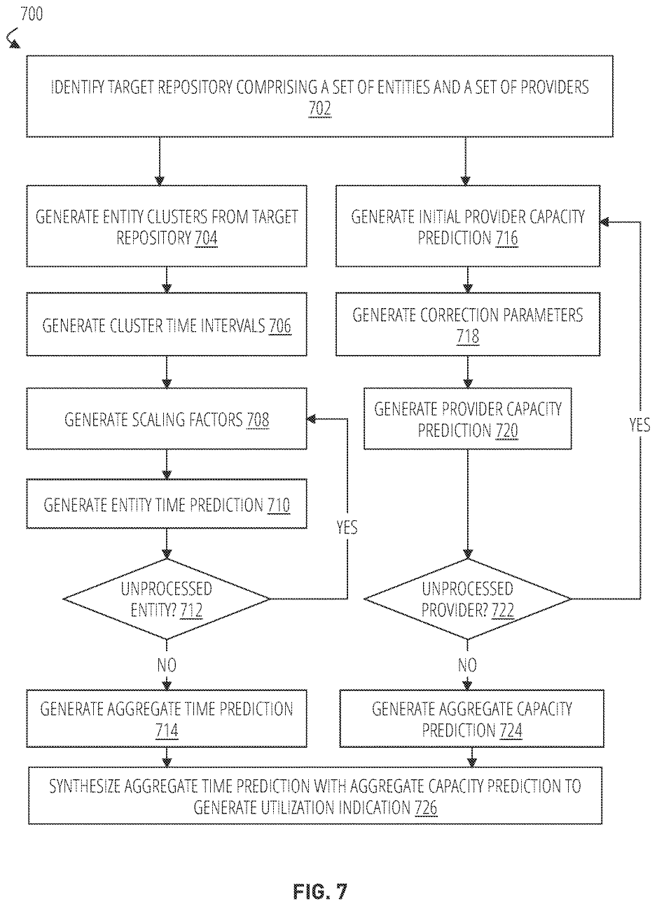

FIG. 7 depicts a flowchart diagram of parallel machine learning optimization process 700 in accordance with some embodiments of the present disclosure. The flowchart diagram depicts a parallel processing technique that handles counteracting variables, in parallel, to optimize a target repository. The process 700 may be implemented by one or more computing devices, entities, and/or systems described herein. For example, via the various steps/operations of the process 700, the computing system 101 may forecast, in parallel, and synthesize aggregate time predictions and/or capacity predictions for a target repository to generate various utilization indications for the target repository. By doing so, the process 700 leverages parallel machine learning pipelines to improve the predictive capabilities of a computer.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700/In other examples, different components of an example device or system that implements the process 700 may perform functions at substantially the same time or in a specific sequence.

In some embodiments, the process 700 comprises, at operation 702, identifying a target repository that comprises a set of entities and a set of providers. For example, the computing system 101 may identify the target repository.

In some embodiments, in a first parallel processing stream, the process 700 comprises, at operation 704, generating a group of entity clusters from the target repository. For example, the computing system 101 may generate, using a clustering model of a time prediction model pipeline, a group of entity clusters from the set of entities associated with the target repository.

In some embodiments, the process 700 comprises, at operation 706, generating cluster time intervals for up to each of the group of entity clusters. For example, the computing system 101 may generate, at a first stage, a set of cluster time intervals for an entity cluster of the group of entity clusters. The set of cluster time intervals, for example, may comprise a cluster time interval that corresponds to a defined prediction bucket of a set of defined prediction buckets. In some examples, up to each of the set of defined prediction buckets may correspond to a different time interval. The computing system 101 may aggregate the set of cluster time intervals to generate an aggregated entity time interval for an entity of the set of entities.

In some examples, the time prediction model pipeline comprises a set of bucketized prediction models that comprises a bucketized regression model corresponding to a bucket-cluster pair comprising the entity cluster of the group of entity clusters and a defined prediction bucket of a set of defined prediction buckets.

In some embodiments, the process 700 comprises, at operation 708, generating scaling factors for an entity of the set of entities. For example, the computing system 101 may generate, at a second stage, an entity scaling factor for an entity of the entity cluster.

In some embodiments, the process 700 comprises, at operation 710, generating an entity time prediction for the entity based on the scaling factors and/or at least one of the cluster time intervals. For example, the computing system 101 may generate an entity time prediction based on (i) the set of cluster time intervals and (ii) the scaling factors (e.g., entity scaling factor, cluster scaling factor). The computing system 101, for example, may apply the entity scaling factor and/or the cluster scaling factor to the aggregated entity time interval to generate the entity time prediction for an entity of the set of entities. In some examples, the entity time prediction may be one of a set of entity time predictions that respectively correspond to the set of entities associated with the target repository.

In some embodiments, the process 700 comprises, at operation 712, determining whether an entity time prediction is generated for up to each of the set of entities of the target repository. In response to an unprocessed entity, the process 700 may return to operation 708 to generate scaling factors and/or an entity time prediction for an unprocessed entity. Otherwise, for example, in response to generating an entity time prediction for up to each of the set of entities, the process 700 may proceed to operation 714.

In some embodiments, the process 700 comprises, at operation 714, generating an aggregate time prediction for the target repository. For example, the computing system 101 may generate, using the time prediction model pipeline, the aggregate time prediction for the target repository. The computing system 101, for example, may generate, at a third stage, the aggregate time prediction based on (i) the set of cluster time intervals and (ii) the one or more scaling factors (e.g., entity scaling factor, cluster scaling factor) for up to each of the set of entities associated with the target repository.

In some embodiments, in a second parallel processing stream, the process 700 comprises, at operation 716, generating an initial provider capacity prediction for a provider from the set of providers. For example, the computing system 101 may determine an initial provider capacity prediction for a provider of the set of providers.

In some embodiments, the process 700 comprises, at operation 718, generating correction parameters for the provider. For example, the computing system 101 may generate, using a second staged prediction model of a capacity prediction model pipeline, a set of correction parameters for the provider. In some examples, the set of correction parameters may comprise an availability prediction, a cross-leverage prediction, and/or a provider churn prediction. The computing system 101 may generate, at a first stage and using a first provider-specific regression model of the second staged prediction model, the availability prediction. The computing system 101 may generate, at a second stage and using a second provider-specific regression model of the second staged prediction model, the cross-leverage prediction. The computing system 101 may generate, at a third stage and using a provider-specific classification model of the second staged prediction model, the provider chum prediction.

In some embodiments, the process 700 comprises, at operation 720, generating a provider capacity prediction. For example, the computing system 101 may synthesize the initial provider capacity prediction with the set of correction parameters to generate the aggregate capacity prediction.

In some embodiments, the process 700 comprises, at operation 722, determining whether a provider capacity prediction is generated for up to each of the set of providers of the target repository. In response to an unprocessed provider, the process 700 may return to operation 716 to generate an initial provider capacity prediction and/or a provider capacity prediction for an unprocessed provider. Otherwise, for example, in response to generating a provider capacity prediction for up to each of the set of providers, the process 700 may proceed to operation 724.

In some embodiments, the process 700 comprises, at operation 724, generating an aggregate capacity prediction for the target repository. For example, the computing system 101 may generate an aggregate capacity prediction for the target repository based on a set of providers associated with the target repository. For instance, the computing system 101 may generate the aggregate time prediction by aggregating the set of entity time predictions.

In some embodiments, the process 700 comprises, at operation 726, synthesizing the aggregate time prediction with the aggregate capacity prediction to generate an utilization indication. For example, the computing system 101 may synthesize the aggregate time prediction and the aggregate capacity prediction to generate a utilization indication for the target repository. For example, the computing system 101 may determine a time capacity ratio by (i) subtracting the aggregate time prediction from the aggregate capacity prediction to determine a capacity utilization and (ii) dividing the capacity utilization by the aggregate capacity prediction to determine the time capacity ratio. The computing system 101 may generate the utilization indication from a set of optimization categories based on the time capacity ratio.

In some examples, the computing system 101 may initiate a performance of a prediction-based action based on the utilization indication. For example, responsive to a first determination that the utilization indication corresponds to an overutilization category, the computing system 101 may divert an entity from the target repository. In addition, or alternatively, responsive to a second determination that the utilization indication corresponds to an underutilization category, the computing system 101 may divert an entity to the target repository.

In some examples, the computing system 101 may determine a loss value based on the aggregate time prediction and/or the aggregate capacity prediction. The computing system 101 may determine a threshold entity limit based on the loss value and/or output the threshold entity limit with the utilization indication.

Some techniques of the present disclosure enable the generation of action outputs that may be performed to initiate one or more real world actions to achieve real-world effects. The techniques of the present disclosure may be used, applied, and/or otherwise leveraged to generate utilization indications and/or other actionable insights for a target repository. In some examples, the utilization indications of the present disclosure may trigger action outputs (e.g., through control instructions) to automate entity/providing filtering, diversion, and/or other actions to optimize the time requirements of a system with its capacity. This may comprise, for example, diverting patients to other providers, onboarding additional computing devices to increase a processing capability within a computing environment, and/or any other action depending on the domain of the target repository. The action outputs may control various aspects of a client device, such as the display, transmission, and/or the like of data reflective of an alert, and/or the like. The alert may be automatically communicated to a user and/or may be used to initiate security protocols (e.g., locking a computer), robotic action (e.g., performing an automated screening process), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters (e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform the steps/operations of a particular example.

Example 1. A computer-implemented method comprising generating, by one or more processors and using a time prediction model pipeline, a group of entity clusters from a set of entities associated with a target repository; generating, by the one or more processors and using the time prediction model pipeline, an aggregate time prediction that aggregates a set of entity time predictions for a set of entities represented within a target repository by generating, at a first stage, a set of cluster time intervals for an entity cluster of the group of entity clusters, wherein (a) a cluster time interval comprises a cluster-level time prediction for an entity cluster with respect to a defined prediction bucket, (b) the entity cluster comprises a subset of entities from the set of entities, and (c) the defined prediction bucket corresponds an particular time interval for a particular event associated with the subset of entities, generating, at a second stage, an entity scaling factor for an entity of the entity cluster, wherein the entity scaling factor comprises a prediction uncertainty value for an entity within the subset of entities and is based on a set of entity attributes of the entity, and generating, at a third stage, the aggregate time prediction based on (i) the set of cluster time intervals and (ii) the entity scaling factor; generating, by the one or more processors, an aggregate capacity prediction for the target repository based on a set of providers associated with the target repository; synthesizing, by the one or more processors, the aggregate time prediction and the aggregate capacity prediction to generate a utilization indication for the target repository; and initiating, by the one or more processors, a performance of a prediction-based action based on the utilization indication.

Example 2. The computer-implemented method of example 1, wherein generating the aggregate time prediction further comprises generating an entity time prediction of the set of entity time predictions based on (i) the set of cluster time intervals and (ii) the entity scaling factor, wherein the set of entity time predictions respectively correspond to the set of entities within the target repository.

Example 3. The computer-implemented method of example 2, wherein generating the entity time prediction comprises aggregating the set of cluster time intervals to generate an aggregated entity time interval; and applying the entity scaling factor and a cluster scaling factor to the aggregated entity time interval to generate the entity time prediction.

Example 4. The computer-implemented method of example 3, wherein the defined prediction bucket is one of a set of defined prediction buckets and each defined prediction bucket of the set of defined prediction buckets corresponds to a different time interval.

Example 5. The computer-implemented method of any of the preceding examples, wherein the time prediction model pipeline comprises a set of bucketized prediction models that comprises a bucket-specific regression model corresponding to a bucket-cluster pair comprising the entity cluster of the group of entity clusters and the defined prediction bucket of a set of defined prediction buckets.

Example 6. The computer-implemented method of any of the preceding examples, wherein generating the aggregate capacity prediction for the target repository based on the set of providers associated with the target repository comprises generating an initial provider capacity prediction for a provider of the set of providers; generating, using a second staged prediction model of a capacity prediction model pipeline, a set of correction parameters for the provider; and synthesizing the initial provider capacity prediction with the set of correction parameters to generate the aggregate capacity prediction.

Example 7. The computer-implemented method of example 6, wherein the set of correction parameters comprises an availability prediction, a cross-leverage prediction, and a provider churn prediction, and generating the set of correction parameters comprises generating, at a first stage and using a first provider-specific regression model of the second staged prediction model, the availability prediction; generating, at a second stage and using a second provider-specific regression model of the second staged prediction model, the cross-leverage prediction; and generating, at a third stage and using a provider-specific classification model of the second staged prediction model, the provider churn prediction.

Example 8. The computer-implemented method of any of the preceding examples, wherein synthesizing the aggregate time prediction and the aggregate capacity prediction comprises determining a time capacity ratio by (i) subtracting the aggregate time prediction from the aggregate capacity prediction to determine a capacity utilization and (ii) dividing the capacity utilization by the aggregate capacity prediction to determine the time capacity ratio; and generating the utilization indication from a set of optimization categories based on the time capacity ratio.

Example 9. The computer-implemented method of example 8, wherein initiating the performance of the prediction-based action comprises responsive to a first determination that the utilization indication corresponds to an overutilization category, diverting an entity from the target repository; or responsive to a second determination that the utilization indication corresponds to an underutilization category, diverting an entity to the target repository.

Example 10. The computer-implemented method of any of the preceding examples, further comprising determining a loss value based on the aggregate time prediction and the aggregate capacity prediction; determining a threshold entity limit based on the loss value; and outputting the threshold entity limit with the utilization indication.

Example 11. A system comprising one or more processors; and one or more memories storing processor-executable instructions that, when executed by the one or more processors, cause the one or more processors to perform operations comprising generating, using a clustering model of a time prediction model pipeline, a group of entity clusters from a set of entities associated with a target repository; generating, using a first staged prediction model of the time prediction model pipeline, an aggregate time prediction for the target repository based on the group of entity clusters by generating, at a first stage and using a set of bucketized prediction models of the first staged prediction model, a set of cluster time intervals for an entity cluster of the group of entity clusters, generating, at a second stage and using an entity classification model of the first staged prediction model, an entity scaling factor for an entity of the entity cluster, and generating, at a third stage of the first staged prediction model, the aggregate time prediction based on (i) the set of cluster time intervals and (ii) the entity scaling factor; generating an aggregate capacity prediction for the target repository based on a set of providers associated with the target repository; synthesizing the aggregate time prediction and the aggregate capacity prediction to generate a utilization indication for the target repository; and initiating a performance of a prediction-based action based on the utilization indication.

Example 12. The system of example 11, wherein generating the aggregate time prediction further comprises generating an entity time prediction based on (i) the set of cluster time intervals and (ii) the entity scaling factor, wherein the entity time prediction is one of a set of entity time predictions that respectively correspond to the set of entities associated with the target repository; and generating the aggregate time prediction by aggregating the set of entity time predictions.

Example 13. The system of example 12, wherein the set of cluster time intervals comprises a cluster time interval that corresponds to a defined prediction bucket of a set of defined prediction buckets and generating the entity time prediction comprises aggregating the set of cluster time intervals to generate an aggregated entity time interval; and applying the entity scaling factor and a cluster scaling factor to the aggregated entity time interval to generate the entity time prediction.

Example 14. The system of example 13, wherein each of the set of defined prediction buckets corresponds to a different time interval.

Example 15. The system of any of examples 11 through 14, wherein the set of bucketized prediction models comprises a bucketized regression model that corresponds to a bucket-cluster pair comprising the entity cluster of the group of entity clusters and a defined prediction bucket of a set of defined prediction buckets.

Example 16. The system of any of examples 11 through 15, wherein generating the aggregate capacity prediction for the target repository based on the set of providers associated with the target repository comprises generating an initial provider capacity prediction for a provider of the set of providers; generating, using a second staged prediction model of a capacity prediction model pipeline, a set of correction parameters for the provider; and synthesizing the initial provider capacity prediction with the set of correction parameters to generate the aggregate capacity prediction.

Example 17. One or more non-transitory computer-readable media storing processor-executable instructions that, when executed by one or more processors, cause the one or more processors to perform operations comprising generating, using a clustering model of a time prediction model pipeline, a group of entity clusters from a set of entities associated with a target repository; generating, using a first staged prediction model of the time prediction model pipeline, an aggregate time prediction for the target repository based on the group of entity clusters by generating, at a first stage and using a set of bucketized prediction models of the first staged prediction model, a set of cluster time intervals for an entity cluster of the group of entity clusters, generating, at a second stage and using an entity classification model of the first staged prediction model, an entity scaling factor for an entity of the entity cluster, and generating, at a third stage of the first staged prediction model, the aggregate time prediction based on (i) the set of cluster time intervals and (ii) the entity scaling factor; generating an aggregate capacity prediction for the target repository based on a set of providers associated with the target repository; synthesizing the aggregate time prediction and the aggregate capacity prediction to generate a utilization indication for the target repository; and initiating a performance of a prediction-based action based on the utilization indication.

Example 18. The one or more non-transitory computer-readable media of example 17, wherein synthesizing the aggregate time prediction and the aggregate capacity prediction comprises determining a time capacity ratio by (i) subtracting the aggregate time prediction from the aggregate capacity prediction to determine a capacity utilization and (ii) dividing the capacity utilization by the aggregate capacity prediction to determine the time capacity ratio; and determining the utilization indication from a set of optimization categories based on the time capacity ratio.

Example 19. The one or more non-transitory computer-readable media of example 18, wherein initiating the performance of the prediction-based action comprises responsive to a first determination that the utilization indication corresponds to an overutilization category, diverting an entity from the target repository; or responsive to a second determination that the utilization indication corresponds to an underutilization category, diverting an entity to the target repository.

Example 20. The one or more non-transitory computer-readable media of any of examples 17 through 19, wherein the operations further comprise determining a loss value based on the aggregate time prediction and the aggregate capacity prediction; determining a threshold entity limit based on the loss value; and outputting the threshold entity limit with the utilization indication.

Example 21. The computer-implemented method of example 1, wherein the method further comprises training the time prediction model pipeline and a capacity prediction model pipeline.

Example 22. The computer-implemented method of example 21, wherein the training is performed by the one or more processors.

Example 23. The computer-implemented method of example 21, wherein the one or more processors are comprised in a first computing entity; and the training is performed by one or more other processors comprised in a second computing entity.

Example 24. The computing system of example 11, wherein the one or more processors are further configured to train the time prediction model pipeline and a capacity prediction model pipeline.

Example 25. The computing system of example 24, wherein the one or more processors are comprised in a first computing entity; and the time prediction model pipeline and the capacity prediction model pipeline are trained by one or more other processors comprised in a second computing entity.

Example 26. The one or more non-transitory computer-readable storage media of example 17, wherein the instructions further cause the one or more processors to train the time prediction model pipeline and a capacity prediction model pipeline.

Example 27. The one or more non-transitory computer-readable storage media of example 26, wherein the one or more processors are comprised in a first computing entity; and the time prediction model pipeline and the capacity prediction model pipeline are trained by one or more other processors comprised in a second computing entity.

What is claimed is:

1. A computer-implemented method comprising:
generating, by one or more processors and using a time prediction model pipeline, a group of entity clusters from a set of entities associated with a target repository;
generating, by the one or more processors and using the time prediction model pipeline, an aggregate time prediction that aggregates a set of entity time predictions for a set of entities represented within a target repository by:
generating, at a first stage, a set of cluster time intervals for an entity cluster of the group of entity clusters, wherein (a) a cluster time interval comprises a cluster-level time prediction for an entity cluster with respect to a defined prediction bucket, (b) the entity cluster comprises a subset of entities from the set of entities, and (c) the defined prediction bucket corresponds an particular time interval for a particular event associated with the subset of entities,
generating, at a second stage, an entity scaling factor for an entity of the entity cluster, wherein the entity scaling factor comprises a prediction uncertainty value for an entity within the subset of entities and is based on a set of entity attributes of the entity, and
generating, at a third stage, the aggregate time prediction based on (i) the set of cluster time intervals and (ii) the entity scaling factor;
generating, by the one or more processors, an aggregate capacity prediction for the target repository based on a set of providers associated with the target repository;
synthesizing, by the one or more processors, the aggregate time prediction and the aggregate capacity prediction to generate a utilization indication for the target repository; and
initiating, by the one or more processors, a performance of a prediction-based action based on the utilization indication.

2. The computer-implemented method of claim 1, wherein generating the aggregate time prediction further comprises generating an entity time prediction of the set of entity time predictions based on (i) the set of cluster time intervals and (ii) the entity scaling factor, wherein the set of entity time predictions respectively correspond to the set of entities within the target repository.

3. The computer-implemented method of claim 2, wherein generating the entity time prediction comprises:
aggregating the set of cluster time intervals to generate an aggregated entity time interval; and
applying the entity scaling factor and a cluster scaling factor to the aggregated entity time interval to generate the entity time prediction.

4. The computer-implemented method of claim 3, wherein the defined prediction bucket is one of a set of defined prediction buckets and each defined prediction bucket of the set of defined prediction buckets corresponds to a different time interval.

5. The computer-implemented method of claim 1, wherein the time prediction model pipeline comprises a set of bucketized prediction models that comprises a bucket-specific regression model corresponding to a bucket-cluster pair comprising the entity cluster of the group of entity clusters and the defined prediction bucket of a set of defined prediction buckets.

6. The computer-implemented method of claim 1, wherein generating the aggregate capacity prediction for the target repository based on the set of providers associated with the target repository comprises:
generating an initial provider capacity prediction for a provider of the set of providers;
generating, using a second staged prediction model of a capacity prediction model pipeline, a set of correction parameters for the provider; and
synthesizing the initial provider capacity prediction with the set of correction parameters to generate the aggregate capacity prediction.

7. The computer-implemented method of claim 6, wherein the set of correction parameters comprises an availability prediction, a cross-leverage prediction, and a provider churn prediction, and generating the set of correction parameters comprises:
generating, at a first stage and using a first provider-specific regression model of the second staged prediction model, the availability prediction;
generating, at a second stage and using a second provider-specific regression model of the second staged prediction model, the cross-leverage prediction; and
generating, at a third stage and using a provider-specific classification model of the second staged prediction model, the provider chum prediction.

8. The computer-implemented method of claim 1, wherein synthesizing the aggregate time prediction and the aggregate capacity prediction comprises:
determining a time capacity ratio by (i) subtracting the aggregate time prediction from the aggregate capacity prediction to determine a capacity utilization and (ii) dividing the capacity utilization by the aggregate capacity prediction to determine the time capacity ratio; and
generating the utilization indication from a set of optimization categories based on the time capacity ratio.

9. The computer-implemented method of claim 8, wherein initiating the performance of the prediction-based action comprises:
responsive to a first determination that the utilization indication corresponds to an overutilization category, diverting an entity from the target repository; or
responsive to a second determination that the utilization indication corresponds to an underutilization category, diverting an entity to the target repository.

10. The computer-implemented method of claim 1, further comprising:
determining a loss value based on the aggregate time prediction and the aggregate capacity prediction;
determining a threshold entity limit based on the loss value; and
outputting the threshold entity limit with the utilization indication.

11. A system comprising:
one or more processors; and
one or more memories storing processor-executable instructions that, when executed by the one or more processors, cause the one or more processors to perform operations comprising:
generating, using a clustering model of a time prediction model pipeline, a group of entity clusters from a set of entities associated with a target repository;
generating, using a first staged prediction model of the time prediction model pipeline, an aggregate time prediction for the target repository based on the group of entity clusters by:
generating, at a first stage and using a set of bucketized prediction models of the first staged prediction model, a set of cluster time intervals for an entity cluster of the group of entity clusters,
generating, at a second stage and using an entity classification model of the first staged prediction model, an entity scaling factor for an entity of the entity cluster, and
generating, at a third stage of the first staged prediction model, the aggregate time prediction based on (i) the set of cluster time intervals and (ii) the entity scaling factor;
generating an aggregate capacity prediction for the target repository based on a set of providers associated with the target repository;
synthesizing the aggregate time prediction and the aggregate capacity prediction to generate a utilization indication for the target repository; and
initiating a performance of a prediction-based action based on the utilization indication.

12. The system of claim 11, wherein generating the aggregate time prediction further comprises:
generating an entity time prediction based on (i) the set of cluster time intervals and (ii) the entity scaling factor, wherein the entity time prediction is one of a set of entity time predictions that respectively correspond to the set of entities associated with the target repository; and
generating the aggregate time prediction by aggregating the set of entity time predictions.

13. The system of claim 12, wherein the set of cluster time intervals comprises a cluster time interval that corresponds to a defined prediction bucket of a set of defined prediction buckets and generating the entity time prediction comprises:
aggregating the set of cluster time intervals to generate an aggregated entity time interval; and
applying the entity scaling factor and a cluster scaling factor to the aggregated entity time interval to generate the entity time prediction.

14. The system of claim 13, wherein each of the set of defined prediction buckets corresponds to a different time interval.

15. The system of claim 11, wherein the set of bucketized prediction models comprises a bucketized regression model that corresponds to a bucket-cluster pair comprising the entity cluster of the group of entity clusters and a defined prediction bucket of a set of defined prediction buckets.

16. The system of claim 11, wherein generating the aggregate capacity prediction for the target repository based on the set of providers associated with the target repository comprises:
generating an initial provider capacity prediction for a provider of the set of providers;
generating, using a second staged prediction model of a capacity prediction model pipeline, a set of correction parameters for the provider; and
synthesizing the initial provider capacity prediction with the set of correction parameters to generate the aggregate capacity prediction.

17. One or more non-transitory computer-readable media storing processor-executable instructions that, when executed by one or more processors, cause the one or more processors to perform operations comprising:
generating, using a clustering model of a time prediction model pipeline, a group of entity clusters from a set of entities associated with a target repository;
generating, using a first staged prediction model of the time prediction model pipeline, an aggregate time prediction for the target repository based on the group of entity clusters by:
generating, at a first stage and using a set of bucketized prediction models of the first staged prediction model, a set of cluster time intervals for an entity cluster of the group of entity clusters,
generating, at a second stage and using an entity classification model of the first staged prediction model, an entity scaling factor for an entity of the entity cluster, and
generating, at a third stage of the first staged prediction model, the aggregate time prediction based on (i) the set of cluster time intervals and (ii) the entity scaling factor;
generating an aggregate capacity prediction for the target repository based on a set of providers associated with the target repository;
synthesizing the aggregate time prediction and the aggregate capacity prediction to generate a utilization indication for the target repository; and
initiating a performance of a prediction-based action based on the utilization indication.

18. The one or more non-transitory computer-readable media of claim 17, wherein synthesizing the aggregate time prediction and the aggregate capacity prediction comprises:
determining a time capacity ratio by (i) subtracting the aggregate time prediction from the aggregate capacity prediction to determine a capacity utilization and (ii) dividing the capacity utilization by the aggregate capacity prediction to determine the time capacity ratio; and
determining the utilization indication from a set of optimization categories based on the time capacity ratio.

19. The one or more non-transitory computer-readable media of claim 18, wherein initiating the performance of the prediction-based action comprises:
responsive to a first determination that the utilization indication corresponds to an overutilization category, diverting an entity from the target repository; or
responsive to a second determination that the utilization indication corresponds to an underutilization category, diverting an entity to the target repository.

20. The one or more non-transitory computer-readable media of claim 17, wherein the operations further comprise:
determining a loss value based on the aggregate time prediction and the aggregate capacity prediction;
determining a threshold entity limit based on the loss value; and
outputting the threshold entity limit with the utilization indication.
